(19) United States
(12) Patent Application Publication
(10) Pub. No.: US 2020/0410379 A1
(43) Pub. Date: Dec. 31, 2020

(54) COMPUTATIONAL CREATIVITY BASED ON A TUNABLE CREATIVITY CONTROL FUNCTION OF A MODEL

(71) Applicant: International Business Machines Corporation, Armonk, NY (US)

(72) Inventors: Payel Das, Yorktown Heights, NY (US); Aleksandra Mojsilovic, New York, NY (US); Eric Johnson, Seattle, WA (US); Kahini Wadhawan, White Plains, NY (US); Pin-Yu Chen, White Plains, NY (US)

(21) Appl. No.: 16/457,392

(22) Filed: Jun. 28, 2019

(51) Int. Cl. G06N 5/04; G06N 20/00

(52) U.S. Cl. CPC G06N 5/048; G06N 20/00

(57) ABSTRACT

Systems, computer-implemented methods, and computer program products that can facilitate computational creativity are provided. According to an embodiment, a system can comprise a memory that stores computer executable components and a processor that executes the computer executable components stored in the memory. The computer executable components can comprise a learner component that learns mappings of data features from a feature space to a creativity attribute of a model to define a creativity control function of the model. The computer executable components can further comprise a generator component that employs the model to generate a creative data sample based on the creativity control function.

### BACKGROUND

The subject disclosure relates to computational creativity, and more specifically, to computational creativity based on a tunable creativity control function of a model.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, and/or computer program products that can facilitate computational creativity are described.

According to an embodiment, a system can comprise a memory that stores computer executable components and a processor that executes the computer executable components stored in the memory. The computer executable components can comprise a learner component that learns mappings of data features from a feature space to a creativity attribute of a model to define a creativity control function of the model. The computer executable components can further comprise a generator component that employs the model to generate a creative data sample based on the creativity control function.

According to another embodiment, a computer-implemented method can comprise learning, by a system operatively coupled to a processor, mappings of data features from a feature space to a creativity attribute of a model to define a creativity control function of the model. The computer-implemented method can further comprise employing, by the system, the model to generate a creative data sample based on the creativity control function.

According to another embodiment, a computer program product facilitating computational creativity is provided. The computer program product comprising a computer readable storage medium having program instructions embodied therewith, the program instructions executable by a processor to cause the processor to learn, by the processor, mappings of data features from a feature space to a creativity attribute of a model to define a creativity control function of the model. The program instructions are further executable by the processor to cause the processor to employ, by the processor, the model to generate a creative data sample based on the creativity control function.

### DESCRIPTION OF THE DRAWINGS

FIG. 1 illustrates a block diagram of an example, non-limiting system that can facilitate computational creativity in accordance with one or more embodiments described herein.

FIG. 2 illustrates a block diagram of an example, non-limiting system that can facilitate computational creativity in accordance with one or more embodiments described herein.

FIG. 3 illustrates a diagram of an example, non-limiting system that can facilitate computational creativity in accordance with one or more embodiments described herein.

FIG. 4 illustrates a diagram of an example, non-limiting system that can facilitate computational creativity in accordance with one or more embodiments described herein.

FIGS. 5A and 5B illustrate diagrams of example, non-limiting systems that can facilitate computational creativity in accordance with one or more embodiments described herein.

FIG. 6 illustrates a diagram of an example, non-limiting system that can facilitate computational creativity in accordance with one or more embodiments described herein.

FIGS. 7A, 7B, 7C, 7D, and 7E illustrate diagrams of example, non-limiting systems that can facilitate computational creativity in accordance with one or more embodiments described herein.

FIG. 8 illustrates a diagram of an example, non-limiting information that can facilitate computational creativity in accordance with one or more embodiments described herein.

FIG. 9 illustrates a flow diagram of an example, non-limiting computer-implemented method that can facilitate computational creativity in accordance with one or more embodiments described herein.

FIG. 10 illustrates a block diagram of an example, non-limiting operating environment in which one or more embodiments described herein can be facilitated.

FIG. 11 illustrates a block diagram of an example, non-limiting cloud computing environment in accordance with one or more embodiments of the subject disclosure.

FIG. 12 illustrates a block diagram of example, non-limiting abstraction model layers in accordance with one or more embodiments of the subject disclosure.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details. Computational Creativity (CC) explores the potential of artificial intelligence to be autonomously creative or to be co-creators with humans. Computational Creativity exploits the knowledge of existing data and/or systems to build an algorithm that will output new ideas or artefacts. Applications range from image generation, creative language, science (e.g., chemistry, physics, and math) to game design. However, current CC models are mostly generative, not creative, as they do not create new, surprising, and valuable ideas or artefacts. The current CC models do not (1) create their own value function (also referred to herein as a utility function, control function, creative control function, etc.), (2) assess the value of a created sample by considering both reward and risk, or (3) have autonomy.

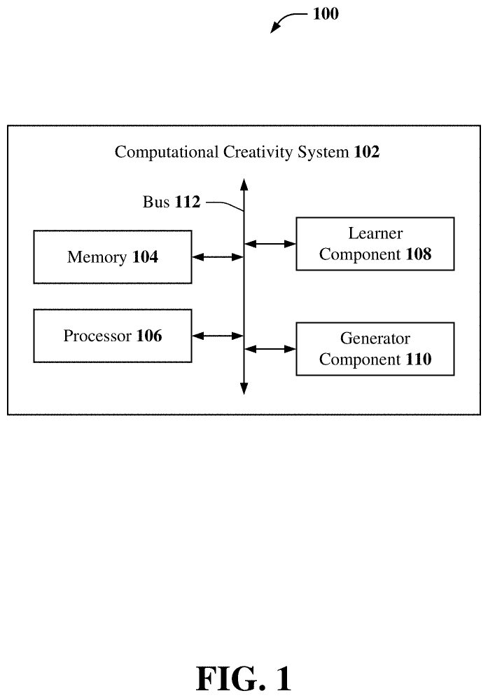

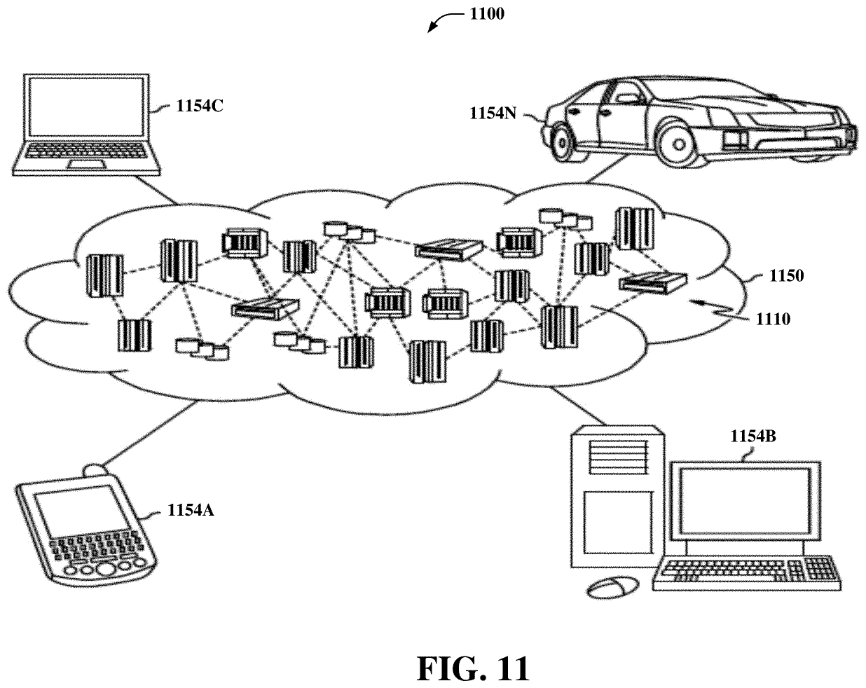

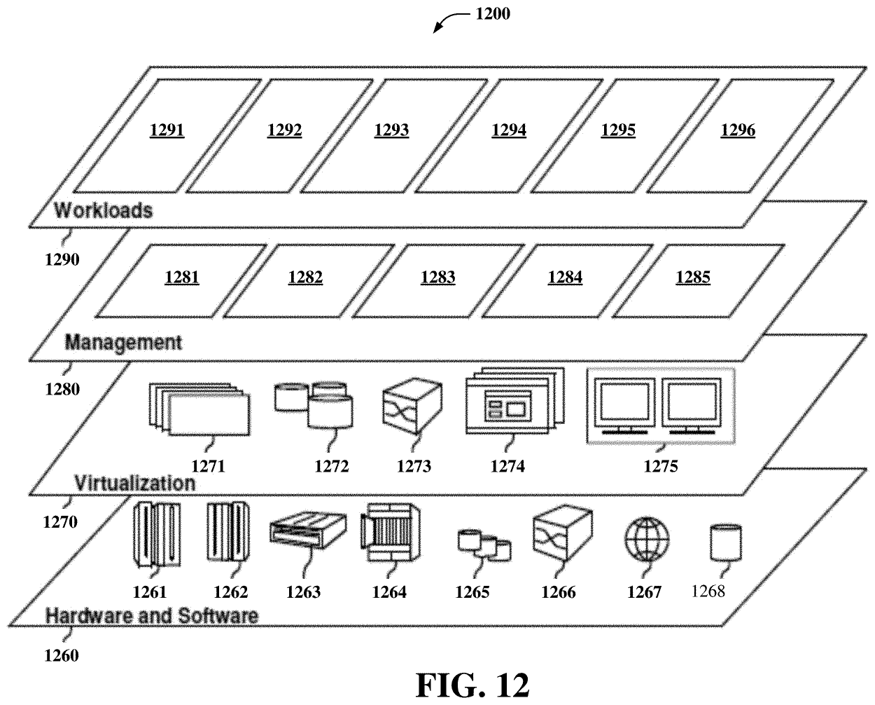

FIG. 1 illustrates a block diagram of an example, non-limiting system 100 that can facilitate computational creativity in accordance with one or more embodiments described herein. In some embodiments, system 100 can comprise a computational creativity system 102. In some embodiments, computational creativity system 102 can be associated with a cloud computing environment. For example, computational creativity system 102 can be associated with cloud computing environment 1150 described below with reference to FIG. 11 and/or one or more functional abstraction layers described below with reference to FIG. 12 (e.g., hardware and software layer 1260, virtualization layer 1270, management layer 1280, and/or workloads layer 1290).

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as Follows

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

### Service Models are as Follows

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as Follows

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Continuing now with FIG. 1, according to several embodiments, system 100 can comprise computational creativity system 102. In some embodiments, computational creativity system 102 can comprise a memory 104, a processor 106, a learner component 108, a generator component 110, and/or a bus 112.

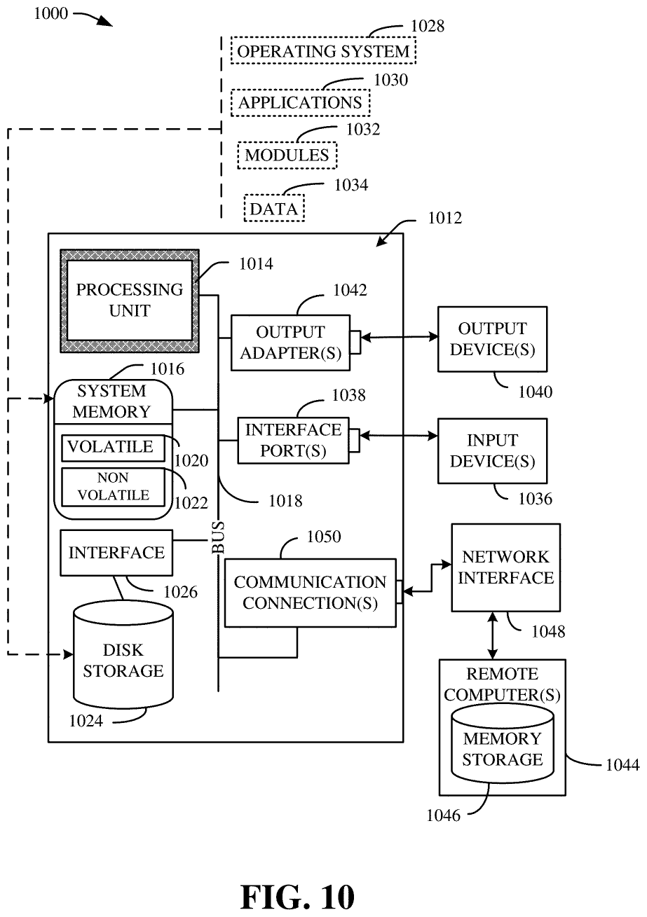

It should be appreciated that the embodiments of the subject disclosure depicted in various figures disclosed herein are for illustration only, and as such, the architecture of such embodiments are not limited to the systems, devices, or components depicted therein. For example, in some embodiments, system 100 and/or computational creativity system 102 can further comprise various computer and/or computing-based elements described herein with reference to operating environment 1000 and FIG. 10. In several embodiments, such computer or computing-based elements can be used in connection with implementing one or more of the systems, devices, components, or computer-implemented operations shown and described in connection with FIG. 1 or other figures disclosed herein.

According to multiple embodiments, memory 104 can store one or more computer or machine readable, writable, or executable components or instructions that, when executed by processor 106, can facilitate performance of operations defined by the executable component(s) or instruction(s). For example, memory 104 can store computer or machine readable, writable, or executable components or instructions that, when executed by processor 106, can facilitate execution of the various functions described herein relating to computational creativity system 102, learner component 108, generator component 110, and/or another component associated with computational creativity system 102, as described herein with or without reference to the various figures of the subject disclosure.

In some embodiments, memory 104 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 104 are described below with reference to system memory 1016 and FIG. 10. Such examples of memory 104 can be employed to implement any embodiments of the subject disclosure.

According to multiple embodiments, processor 106 can comprise one or more types of processors or electronic circuitry that can implement one or more computer and/or machine readable, writable, and/or executable components and/or instructions that can be stored on memory 104. For example, processor 106 can perform various operations that can be specified by such computer and/or machine readable, writable, and/or executable components and/or instructions including, but not limited to, logic, control, input/output (I/O), arithmetic, and/or the like. In some embodiments, processor 106 can comprise one or more central processing unit, multi-core processor, microprocessor, dual microprocessors, microcontroller, System on a Chip (SOC), array processor, vector processor, and/or another type of processor. Further examples of processor 106 are described below with reference to processing unit 1014 and FIG. 10. Such examples of processor 106 can be employed to implement any embodiments of the subject disclosure.

In some embodiments, computational creativity system 102, memory 104, processor 106, learner component 108, generator component 110, and/or another component of computational creativity system 102 as described herein can be communicatively, electrically, and/or operatively coupled to one another via a bus 112 to perform functions of system 100, computational creativity system 102, and/or any components coupled therewith. In several embodiments, bus 112 can comprise one or more memory bus, memory controller, peripheral bus, external bus, local bus, and/or another type of bus that can employ various bus architectures. Further examples of bus 112 are described below with reference to system bus 1018 and FIG. 10. Such examples of bus 112 can be employed to implement any embodiments of the subject disclosure.

According to multiple embodiments, computational creativity system 102 can comprise any type of component, machine, device, facility, apparatus, and/or instrument that comprises a processor and/or can be capable of effective and/or operative communication with a wired and/or wireless network. All such embodiments are envisioned. For example, computational creativity system 102 can comprise a server device, a computing device, a general-purpose computer, a special-purpose computer, a quantum computing device (e.g., a quantum computer, a quantum processor, etc.), a tablet computing device, a handheld device, a server class computing machine and/or database, a laptop computer, a notebook computer, a desktop computer, a cell phone, a smart phone, a consumer appliance and/or instrumentation, an industrial and/or commercial device, a digital assistant, a multimedia Internet enabled phone, a multimedia players, and/or another type of device.

In some embodiments, computational creativity system 102 can be coupled (e.g., communicatively, electrically, operatively, etc.) to one or more external systems, sources, and/or devices (e.g., computing devices, communication devices, etc.) via a data cable (e.g., High-Definition Multimedia Interface (HDMI), recommended standard (RS) 232, Ethernet cable, etc.). In some embodiments, computational creativity system 102 can be coupled (e.g., communicatively, electrically, operatively, etc.) to one or more external systems, sources, and/or devices (e.g., computing devices, communication devices, etc.) via a network.

According to multiple embodiments, such a network can comprise wired and/or wireless networks, including, but not limited to, a cellular network, a wide area network (WAN) (e.g., the Internet), and/or a local area network (LAN). For example, computational creativity system 102 can communicate with one or more external systems, sources, and/or devices, for instance, computing devices (and vice versa) using virtually any desired wired or wireless technology, including but not limited to: wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Zigbee and other 802.XX wireless technologies or legacy telecommunication technologies, BLUETOOTH®, Session Initiation Protocol (SIP), ZIGBEE®, RF4CE protocol, WirelessHART protocol, 6LoWPAN (IPv6 over Low power Wireless Area Networks), Z-Wave, an ANT, an ultra-wideband (UWB) standard protocol, and/or other proprietary and non-proprietary communication protocols. In such an example, computational creativity system 102 can thus include hardware (e.g., a central processing unit (CPU), a transceiver, a decoder), software (e.g., a set of threads, a set of processes, software in execution) and/or a combination of hardware and software that facilitates communicating information between computational creativity system 102 and external systems, sources, and/or devices (e.g., computing devices, communication devices, etc.).

In some embodiments, computational creativity system 102 can comprise one or more computer and/or machine readable, writable, and/or executable components and/or instructions that, when executed by processor 106, can facilitate performance of operations defined by such component(s) and/or instruction(s). Further, in some embodiments, any component associated with computational creativity system 102, as described herein with or without reference to the various figures of the subject disclosure, can comprise one or more computer and/or machine readable, writable, and/or executable components and/or instructions that, when executed by processor 106, can facilitate performance of operations defined by such component(s) and/or instruction(s). For example, learner component 108, generator component 110, and/or any other components associated with computational creativity system 102 as disclosed herein (e.g., communicatively, electronically, and/or operatively coupled with or employed by computational creativity system 102), can comprise such computer and/or machine readable, writable, and/or executable component(s) and/or instruction(s). Consequently, in some embodiments, computational creativity system 102 and/or any components associated therewith as disclosed herein, can employ processor 106 to execute such computer and/or machine readable, writable, and/or executable component(s) and/or instruction(s) to facilitate performance of one or more operations described herein with reference to computational creativity system 102 and/or any such components associated therewith.

In some embodiments, computational creativity system 102 can facilitate performance of operations executed by and/or associated with learner component 108, generator component 110, and/or another component associated with computational creativity system 102 as disclosed herein. For example, as described in detail below, computational creativity system 102 can facilitate (e.g., via processor 106): learning mappings of data features from a feature space to a creativity attribute (e.g., novelty, surprise, and/or value in terms of, for instance, risk versus reward) of a model to define a creativity control function of the model; and/or employing the model to generate a creative data sample based on the creativity control function.

In some embodiments, computational creativity system 102 can further facilitate (e.g., via processor 106): learning the mappings of the data features from the feature space to multiple creativity attributes of the model to define multiple creativity control functions of the model, where the multiple creativity control functions comprise one or more weight values; learning the mappings based on at least one of feedback data, single dimension data, multiple dimension data, single resolution data, or multiple resolution data; assessing authenticity of the creative data sample based on historical data; adjusting a weight value of the creativity control function based on at least one of expert feedback data or a defined weight value of the creativity control function; ranking the creative data sample based on a creativity metric; predicting the creativity attribute based on the creative data sample; and/or determining whether the creativity attribute was predicted by a computing entity or a human entity.

According to multiple embodiments, learner component 108 can learn mappings of data features from a feature space to one or more creativity attributes of a model to define one or more creativity control functions of the model. For example, learner component 108 can learn mappings of data features from a feature space (e.g., a latent space) to one or more creativity attributes of an artificial intelligence (AI) model to define one or more creativity control functions of the AI model, where such one or more creativity attributes can include, but are not limited to, novelty, surprise, value (e.g., in terms of risk versus reward), and/or another creativity attribute of an AI model.

In some embodiments, such one or more creativity control functions can include, but are not limited to, a novelty control function, a surprise control function, a value control function, a risk control function, a reward control function, and/or another creativity control function. In some embodiments, such a value control function can comprise such a risk control function and/or such a reward control function (e.g., where such a risk control function and/or such a reward control function can comprise a sub-creativity control function(s) of the value control function). In some embodiments, such one or more creativity control functions can comprise one or more weight values (e.g., control setting value(s)) that can dictate how much a corresponding creativity attribute of the AI model can affect a data sample generated by such an AI model (e.g., via generator component 110 as described below). In some embodiments, such one or more creativity control functions can comprise tunable creativity control functions including, but not limited to, a tunable novelty control function, a tunable surprise control function, a tunable value control function, a tunable risk control function, a tunable reward control function, and/or another tunable creativity control function.

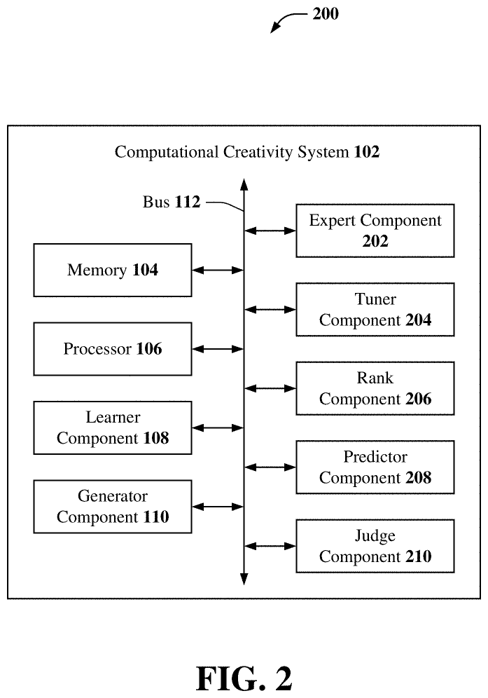

In some embodiments, learner component 108 can employ one or more models such as, for instance, AI models to learn mappings of data features from a feature space to one or more creativity attributes of an AI model to define one or more creativity control functions of the AI model. For example, as described below with reference to FIGS. 2, 3, 6, 7A, 7B, 7C, 7D, and/or 7E, learner component 108 can employ one or more AI models including, but not limited to, a neural network, a generative adversarial network (GAN), an autoencoder, a variational autoencoder, and/or another AI model that can facilitate learning mappings of data features from a feature space to one or more creativity attributes of an AI model to define one or more creativity control functions of the AI model.

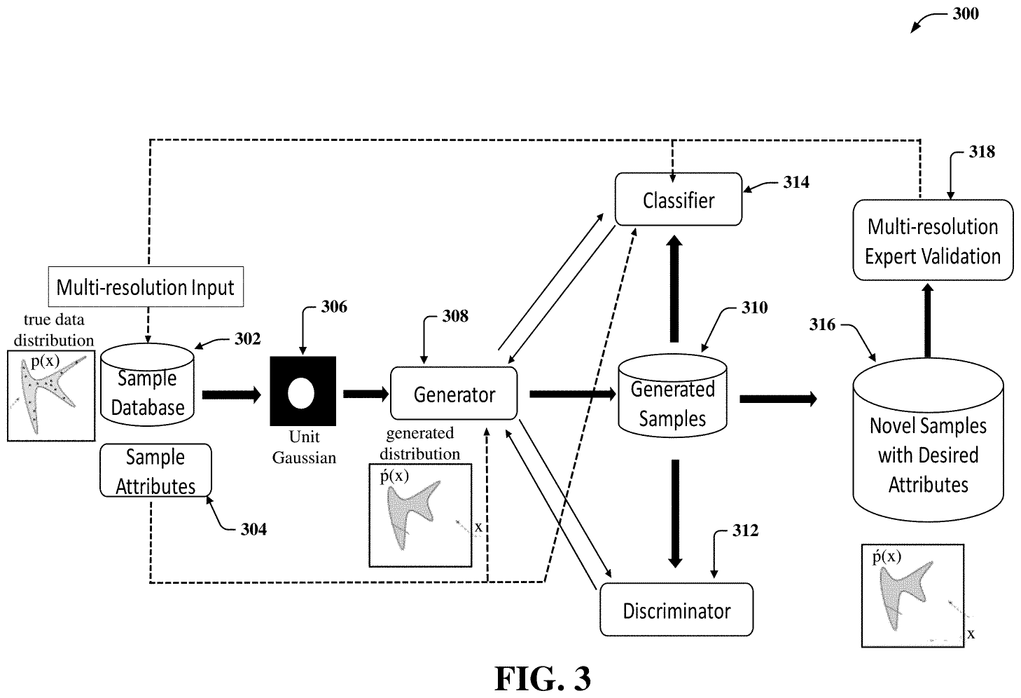

In some embodiments, learner component 108 can learn mappings of data features from a feature space to one or more creativity attributes of an AI model based on at least one of feedback data, single dimension data, multiple dimension data, single resolution data, or multiple resolution data. For example, as described below with reference to FIGS. 2 and 3, learner component 108 can learn such mappings based on feedback data from an AI model (e.g., a generator, a classifier, a discriminator, etc.) that can analyze a data sample generated by generator component 110. In this example, learner component 108 can further learn such mappings based on expert feedback data and/or multi-resolution expert validation data corresponding to a data sample generated by generator component 110, where such a data sample can include, but is not limited to, single dimension data, multiple dimension data, single resolution data, multiple resolution data, and/or another data sample.

In some embodiments, computational creativity system 102 can present to an entity (e.g., a human, a computing device, a software application, an expert agent, an AI model, etc.) a data sample generated by generator component 110 and/or receive feedback data from such an entity corresponding to the data sample. For example, computational creativity system 102 can comprise an interface component including, but not limited to, an application programming interface (API), a graphical user interface (GUI), and/or another interface component that can present to an entity (e.g., via a computer monitor, a display, a screen, etc.) such a data sample generated by generator component 110 and/or receive feedback data from the entity corresponding to the data sample. For instance, computational creativity system 102 can comprise an interface component that can present such a data sample to an entity by displaying it on a computer monitor, for example, and/or can receive feedback data from the entity via one or more input controls of such an interface component (e.g., input controls of a GUI) such as, for example, a text field, a button, a seek bar, a checkbox, a toggle button, a zoom button, and/or another input control.

In some embodiments, such feedback data (e.g., expert feedback data, AI model feedback data) received from an entity as described above can comprise historical data corresponding to one or more data samples that can be generated by generator component 110. In some embodiments, computational creativity system 102 and/or learner component 108 can compile such historical data into a historical data index (e.g., a log) that can be stored on a memory device such as, for instance, memory 104 and/or a remote memory device (e.g., a memory device of a remote server).

In some embodiments, such historical data can comprise training data that learner component 108 can use to learn mappings of data features from a feature space to one or more creativity attributes of an AI model. For example, learner component 108 can comprise and/or employ one or more artificial intelligence (AI) models and/or one or more machine learning (ML) models to learn such mappings of data features from a feature space to one or more creativity attributes of an AI model as described above based on explicit learning and/or implicit learning. For instance, learner component 108 can comprise and/or employ an AI model to learn such mappings based on explicit learning (e.g., supervised learning, reinforcement learning, etc.), where previously obtained historical data corresponding to one or more data samples generated by generator component 110 can be used by learner component 108 as training data to learn such mappings. In another example, learner component 108 can comprise and/or employ an AI model to learn such mappings based on implicit learning (e.g., unsupervised learning), where such feedback data (e.g., expert feedback data, AI model feedback data) received from the entity as described above can be used by learner component 108 as training data to learn such mappings.

In some embodiments, learner component 108 can learn such mappings of data features from a feature space to one or more creativity attributes of an AI model as described above based on classifications, correlations, inferences and/or expressions associated with principles of artificial intelligence. For instance, learner component 108 can employ an automatic classification system and/or an automatic classification process to learn such mappings based on feedback data (e.g., expert feedback data, AI model feedback data) received from the entity. In one embodiment, learner component 108 can employ a probabilistic and/or statistical-based analysis (e.g., factoring into the analysis utilities and costs) to learn such mappings based on such feedback data received from the entity.

In some embodiments, learner component 108 can employ any suitable machine learning based techniques, statistical-based techniques, and/or probabilistic-based techniques to learn such mappings of data features from a feature space to one or more creativity attributes of an AI model as described above based on feedback data (e.g., expert feedback data, AI model feedback data) received from the entity. For example, learner component 108 can employ an expert system, fuzzy logic, support vector machine (SVM), Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, and/or another model. In some embodiments, learner component 108 can perform a set of machine learning computations associated with learning such mappings of data features from a feature space to one or more creativity attributes of an AI model as described above based on feedback data (e.g., expert feedback data, AI model feedback data) received from the entity. For example, learner component 108 can perform a set of clustering machine learning computations, a set of logistic regression machine learning computations, a set of decision tree machine learning computations, a set of random forest machine learning computations, a set of regression tree machine learning computations, a set of least square machine learning computations, a set of instance-based machine learning computations, a set of regression machine learning computations, a set of support vector regression machine learning computations, a set of k-means machine learning computations, a set of spectral clustering machine learning computations, a set of rule learning machine learning computations, a set of Bayesian machine learning computations, a set of deep Boltzmann machine computations, a set of deep belief network computations, and/or a set of different machine learning computations to learn such mappings of data features from a feature space to one or more creativity attributes of an AI model as described above based on feedback data (e.g., expert feedback data, AI model feedback data) received from the entity.

According to multiple embodiments, generator component 110 can employ a model to generate a creative data sample based on one or more creativity control functions of the model. For example, generator component 110 can employ an artificial intelligence (AI) model to generate a creative data sample based on one or more creativity control functions of the AI model (e.g., tunable novelty control function, tunable surprise control function, etc.) that can be learned by learner component 108 as described above (e.g., by learning mappings of data features from a feature space (e.g., a latent space) to such one or more creativity attributes of the AI model).

In some embodiments, as described below with reference to FIGS. 3, 6, 7A, 7B, 7C, 7D, and/or 7E, generator component 110 can employ an AI model including, but not limited to, a neural network, a generative adversarial network (GAN), an autoencoder, a variational autoencoder, to generate a creative data sample based on a creativity control function of such an AI model. In this example, generator component 110 can employ an AI model defined above to generate a creative data sample including, but not limited to, a novel data sample, a surprising data sample, a valuable data sample (e.g., valuable in terms of risk versus reward), a single dimension creative data sample, a multiple dimension creative data sample, a single resolution creative data sample, a multiple resolution creative data sample, and/or another creative data sample. In this example, generator component 110 can employ an AI model defined above to generate a creative data sample defined above based on a creativity control function of such an AI model comprising a tunable creativity control function including, but not limited to, a tunable novelty control function, a tunable surprise control function, a tunable value control function, a tunable risk control function, a tunable reward control function, and/or another creativity control function. For instance, generator component 110 can employ an AI model to generate a creative data sample based on one or more weighted values of such one or more tunable creativity control functions defined above.

In some embodiments, generator component 110 can employ an AI model defined above to generate a creative data sample having a creative attribute that is weighted more or less than another creative attribute of such a creative data sample. For example, generator component 110 can employ an AI model defined above to generate a creative data sample having a novelty attribute that is weighted more or less than a surprise attribute of the creative data sample. In some embodiments, to facilitate generating such a creative data sample, generator component 110 can define (e.g., assign, designate, etc.) a weight value of one or more creativity control functions of such an AI model. For example, generator component 110 can employ an AI model defined above to generate a creative data sample having a novelty attribute that is weighted more than a surprise attribute of the creative data sample by assigning a relatively higher weight value to a tunable novelty control function of the AI model and/or by assigning a relatively lower weight value to a tunable surprise control function of the AI model.

In some embodiments, such one or more creativity control functions of an AI model described above can comprise creativity control knobs that can be adjusted to define a weight value corresponding to such one or more creativity attributes of an AI model. In some embodiments, generator component 110 can employ tuner component 204 described below with reference to FIG. 2 to define (e.g., assign, designate, etc.) such a weight value of such one or more creativity control functions of an AI model described above by adjusting the weight value of such one or more creativity control functions defined above. In some embodiments, such a weight value of such one or more creativity control functions (creativity control knobs) can comprise a neutral value, a positive value, a negative value, and/or another value. In some embodiments, such a weight value of such one or more creativity control functions (creativity control knobs) can comprise a discrete value or a continuous value (e.g., a constant value). In some embodiments, such one or more creativity control functions (creativity control knobs) can comprise discrete functions (e.g., discrete time functions) or continuous functions (e.g., continuous time functions).

In some embodiments, such a weight value (e.g., a desired weight value that can enable a desired weight of a corresponding creativity attribute in a generated data sample) of such one or more creativity control functions (creativity control knobs) can be defined by an entity (e.g., a human using an interface component of computational creativity system 102 such as, for instance, a GUI as described above). In some embodiments (e.g., as described below with reference to FIGS. 2, 3, 6, 7A, 7B, 7C, 7D, and/or 7E), such a weight value (e.g., a desired weight value that can enable a desired weight of a corresponding creativity attribute in a generated data sample) of such one or more creativity control functions (creativity control knobs) can be learned by learner component 108 and/or generator component 110 by iteratively and/or incrementally adjusting (e.g., via tuner component 204) such a weight value of such one or more creativity control functions based on expert feedback data (e.g., via expert component 202, expert entity 318, etc.). In some embodiments, one or more new compositions of weight values of such creativity control functions (creativity control knobs) can be learned by learner component 108 and/or generator component 110 by iteratively and/or incrementally adjusting (e.g., via tuner component 204) such weight values of such creativity control functions based on expert feedback data (e.g., via expert component 202, expert entity 318, etc.).

FIG. 2 illustrates a block diagram of an example, non-limiting system 200 that can facilitate computational creativity in accordance with one or more embodiments described herein. In some embodiments, system 200 can comprise computational creativity system 102. In some embodiments, computational creativity system 102 can comprise an expert component 202, a tuner component 204, a rank component 206, a predictor component 208, and/or a judge component 210. Repetitive description of like elements and/or processes employed in respective embodiments is omitted for sake of brevity.

According to multiple embodiments, expert component 202 can assess authenticity of a creative data sample based on historical data. In some embodiments, expert component 202 can comprise expert entity 318 described below with reference to FIG. 3. In some embodiments, expert component 202 can comprise an expert entity including, but not limited to, a human, a computing device, a software application, an expert agent, an AI model, and/or another expert entity that can assess authenticity of a creative data sample based on historical data including, but not limited to, human experience (e.g., experience of a human expert), analytics data, simulation data, training data, ground truth data, and/or other historical data.

In some embodiments, expert component 202 can comprise an expert entity that can assess authenticity of one or more creative data samples based on historical data to determine whether such creative data samples are original data samples (e.g., real data samples) or synthetic data samples (e.g., fake data samples). In some embodiments, expert component 202 can assess the value of such creative data samples based on one or more creativity attributes corresponding to such creative data samples. For example, expert component 202 can assess the value of the creative data samples based on a novelty attribute, a surprise attribute, a value attribute (e.g., in terms of risk versus reward), and/or another creativity attribute. For instance, expert component 202 can assess whether the creative data samples are novel, surprising, and/or valuable (e.g., in terms of risk versus reward). In some embodiments, expert component 202 can perform multi-resolution expert validation. For example, expert component 202 can assess the creative data samples as described above, where such creative data samples can comprise data samples including, but not limited to, single dimension data, multiple dimension data, single resolution data, multiple resolution data, and/or another data sample.

In some embodiments, output determinations by expert component 202 can be provided to computational creativity system 102 and/or one or more components thereof (e.g., learner component 108, generator component 110, etc.) to enable further learning of such a system and/or such components. For example, output determinations by expert component 202 comprising validations of creative data samples can be stored (e.g., by expert component 202) in a memory device (e.g., memory 104) and retrieved by computational creativity system 102 and/or one or more components thereof to enable further learning of such a system and/or such components. In some embodiments, such output determinations by expert component 202 can enable computational creativity system 102 and/or one or more components thereof (e.g., learner component 108, generator component 110, etc.) to assess creative data samples generated by system 200 (e.g., via computational creativity system 102 and/or generator component 110) and to learn to generate new (e.g., original) creative data samples that become more accurate and/or creative (e.g., novel, surprising, valuable, etc.) over time.

According to multiple embodiments, tuner component 204 can adjust a weight value of a creativity control function based on at least one of expert feedback data or a defined weight value of the creativity control function. For example, tuner component 204 can adjust a weight value of one or more creativity control functions comprising one or more of the tunable creativity control functions defined above with reference to FIG. 1 (e.g., a tunable novelty control function, a tunable surprise control function, etc.) based on expert feedback data that can be provided by expert component 202 as described above. In another example, tuner component 204 can adjust a weight value of one or more creativity control functions comprising one or more of the tunable creativity control functions defined above with reference to FIG. 1 (e.g., a tunable novelty control function, a tunable surprise control function, etc.) based on a defined weight value of such one or more creativity control functions that can be defined by an entity (e.g., a human using an interface component of computational creativity system 102 such as, for instance, a GUI as described above).

According to multiple embodiments, rank component 206 can rank a creative data sample based on a creativity metric. For example, rank component 206 can rank a creative data sample based on a creativity metric including, but not limited to, a novelty metric, a surprise metric, a value metric, a risk metric, a reward metric, and/or another metric, where such a creativity metric can be defined (e.g., by rank component 206) to rank a corresponding creativity attribute of one or more generated data samples relative to one another. In this example, rank component 206 can thereby rank the one or more generated data samples relative to one another in terms of such creativity attribute and/or such creativity metric.

In some embodiments, to facilitate such ranking described above, in a feature space corresponding to the creativity attribute (e.g., an original feature space, a learned feature space, a latent feature space, a learned latent feature space, a vector space, a one-dimensional space, a multi-dimensional space, etc.), rank component 206 can compute a distance (e.g., an edit distance, a Euclidean distance, etc.) between a first generated data sample and a set of existing data samples in such a feature space, as well as a distance (e.g., an edit distance, a Euclidean distance, etc.) between a second generated data sample and the set of existing data samples. In some embodiments, rank component 206 can compare such distances from the respective first and second generated data samples to the set of existing data samples in the feature space and based on such distances, rank component 206 can rank such first and second generated data samples in terms of the creativity attribute of the feature space and with respect to one another and/or other generated data samples. For instance, in some embodiments, rank component 206 can assign a lower rank designation to a creativity attribute of a generated data sample having a shorter distance to the set of existing data samples relative to that of one or more other generated data samples and/or a higher rank level to a creativity attribute of a generated data sample having a longer distance to the set of existing data samples relative to that of one or more other generated data samples.

In some embodiments, rank component 206 can define a surprise metric corresponding to a surprise attribute of a generated data sample. In some embodiments, such a surprise metric can be derived (e.g., via rank component 206) from a novelty metric. For example, in a feature space corresponding to a novelty attribute of a generated data sample, if rank component 206 assigns a relatively higher rank designation to a novelty attribute of a first generated data sample and a relatively lower rank designation to a novelty attribute of a second generated data sample, rank component 206 can further assign a relatively higher rank designation to a surprise attribute of the first generated data sample and a relatively lower rank designation to a surprise attribute of the second generated data sample. In this example, the first generated data sample can be considered to have more of a surprise factor (e.g., element) than the second generated data sample.

In some embodiments, rank component 206 can define a value metric corresponding to a value attribute of a generated data sample. In some embodiments, such a value metric can be derived (e.g., via rank component 206) from a risk metric and/or a reward metric. For example, in a feature space corresponding to a risk attribute of a generated data sample, if rank component 206 assigns a relatively higher rank designation to a risk attribute of a first generated data sample and a relatively lower rank designation to a risk attribute of a second generated data sample, rank component 206 can further assign a relatively lower rank designation to a value attribute of the first generated data sample and a relatively higher rank designation to a value attribute of the second generated data sample. In this example, the first generated data sample can be considered to have more of a risk factor (e.g., element) than the second generated data sample, and therefore, can be considered to have less of a value factor than the second generated data sample. In another example, in a feature space corresponding to a reward attribute of a generated data sample, if rank component 206 assigns a relatively higher rank designation to a reward attribute of a first generated data sample and a relatively lower rank designation to a reward attribute of a second generated data sample, rank component 206 can further assign a relatively higher rank designation to a value attribute of the first generated data sample and a relatively lower rank designation to a value attribute of the second generated data sample. In this example, the first generated data sample can be considered to have more of a reward factor (e.g., element) than the second generated data sample, and therefore, can be considered to have more of a value factor than the second generated data sample.

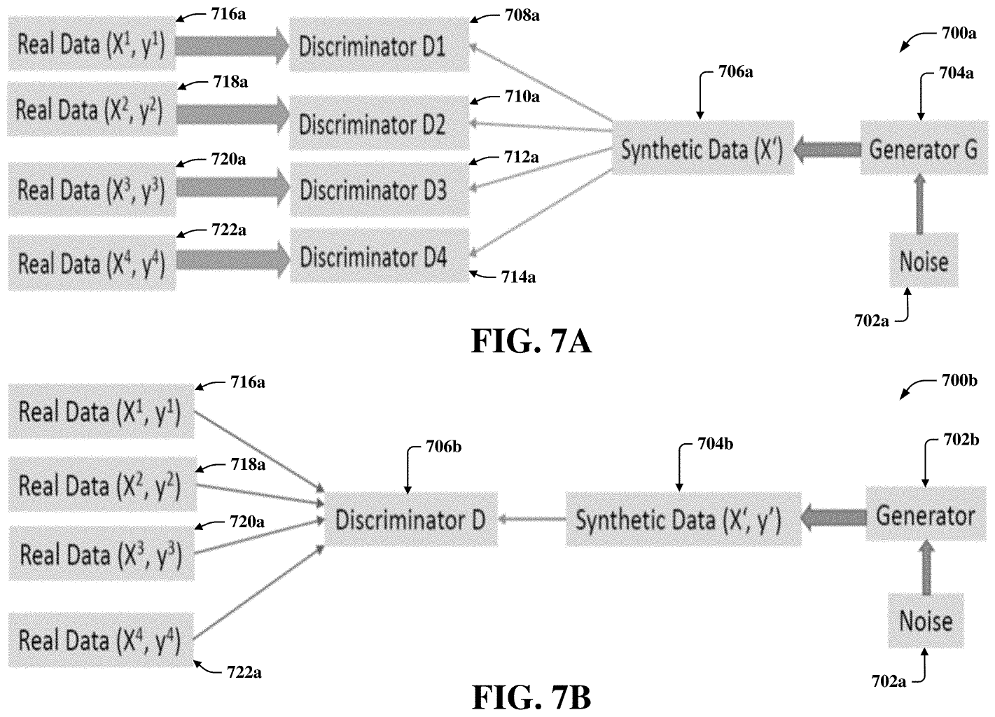

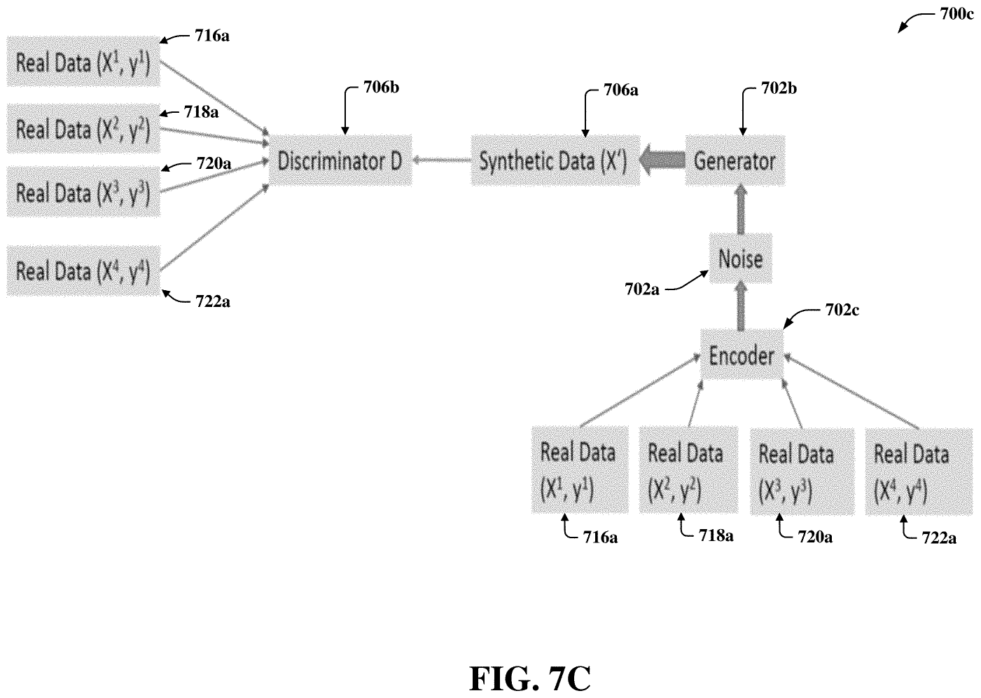

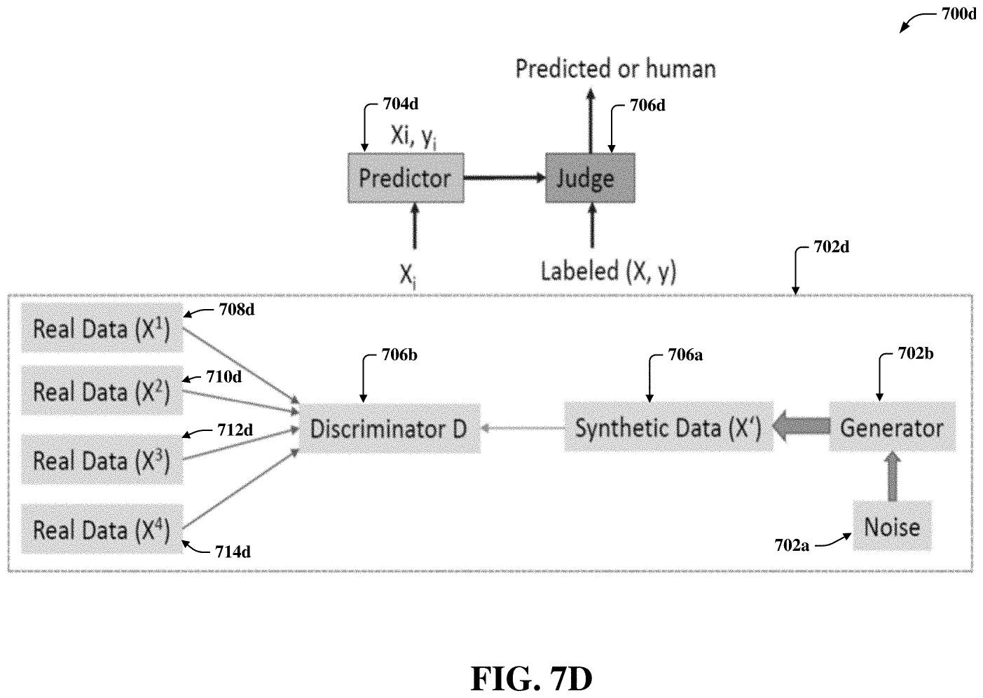

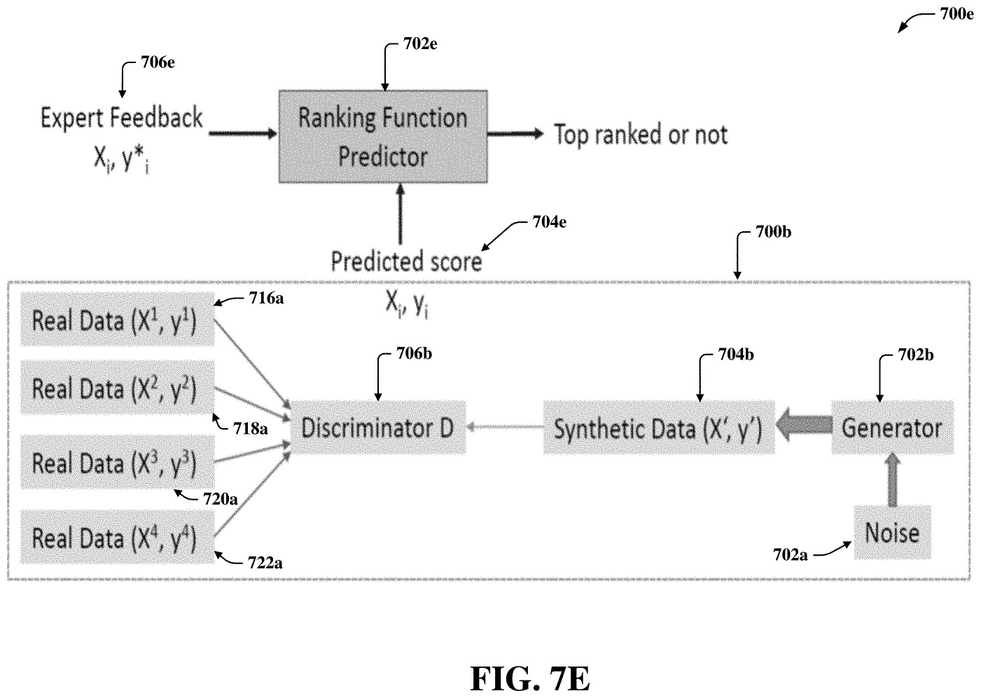

According to multiple embodiments, predictor component 208 can predict a creativity attribute based on a creative data sample. In some embodiments, predictor component 208 can comprise predictor 704d described below with reference to FIG. 7D. In some embodiments, predictor component 208 can comprise a neural network AI model (e.g., a classifier AI model) that can predict a label and/or a classification of a data feature that can be generated by, for instance, system 200 (e.g., via computational creativity system 102 and/or generator component 110). For example, predictor component 208 can predict a label and/or a classification of a data feature where such a label and/or a classification can comprise a creativity attribute (e.g., a novelty attribute, a surprise attribute, a value attribute, etc.). In this example, such a data feature can comprise a creative data sample that can be generated by system 200 (e.g., via computational creativity system 102 and/or generator component 110) and such a creativity attribute that can be predicted by predictor component 208 can correspond to such a data feature.

According to multiple embodiments, judge component 210 can determine whether a creativity attribute was predicted by a predictor component or an entity. In some embodiments, judge component 210 can comprise judge 706d described below with reference to FIG. 7D. In some embodiments, judge component 210 can comprise a neural network AI model (e.g., a discriminative AI model) that can determine whether a creativity attribute was predicted by a computing entity (e.g., a computing device employing an artificial intelligence model and/or a machine learning model) or a human. For example, judge component 210 can comprise a neural network AI model (e.g., a discriminative AI model) that can determine whether a creativity attribute was predicted by predictor component 208 as described above or was predicted by a human In some embodiments, judge component 210 can determine whether such a creativity attribute was predicted by a computing entity (e.g., predictor component 208) or a human based on labeled data that can comprise, for instance, known, original, and/or true data samples (e.g., ground truth data, training data, etc.).

FIG. 3 illustrates a diagram of an example, non-limiting system 300 that can facilitate computational creativity in accordance with one or more embodiments described herein. In some embodiments, system 300 can comprise computational creativity system 102. Repetitive description of like elements and/or processes employed in respective embodiments is omitted for sake of brevity.

According to multiple embodiments, system 300 can comprise a generative adversarial network (GAN) and/or a derivative system. In some embodiments, system 300 can comprise a sample database 302 comprising a quantity of known, true data samples (e.g., ground truth data, training data, etc.). In some embodiments, such known, true data samples of sample database 302 can comprise one or more sample attributes 304 that can comprise creativity attributes including, but not limited to, novelty, surprise, value (e.g., in terms of risk versus reward), and/or another attribute.

In some embodiments, system 300 can comprise one or more AI models including, but not limited to, generator 308, discriminator 312, and/or classifier 314. In some embodiments, generator 308, discriminator 312, and/or classifier 314 can comprise neural network AI models such as, for example, a generative neural network, a discriminative neural network, and/or a classifier neural network, respectively.

In some embodiments, generator 308 can employ a unit Gaussian 306 (e.g., a previously generated data distribution, an approximated data distribution, a simple data distribution, etc.) to learn an original data distribution by generating a sample data distribution that can mimic such an original data distribution. For example, generator 308 can learn such an original data distribution by generating and iteratively fine-tuning (e.g., incrementally adjusting, as needed) such a sample data distribution to a point where such a sample data distribution mimics (e.g., mirrors) such an original data distribution. In some embodiments, by learning such an original data distribution, generator 308 can decode the original data distribution and/or the sample distribution to generate new data samples (e.g., data samples not in the original data distribution or the sample distribution). In some embodiments, such newly generated data samples can be stored in generated samples database 310.

In some embodiments, discriminator 312 can assess such generated data samples of generated samples database 310 to determine whether such generated data samples are original data samples (e.g., real data samples) from sample database 302 or synthetic data samples (e.g., fake data samples). In some embodiments, classifier 314 can assess the value of such generated data samples of generated samples database 310 based on one or more creativity attributes corresponding to such generated data samples of generated samples database 310. For example, classifier 314 can assess the value of such generated data samples of generated samples database 310 based on a novelty attribute, a surprise attribute, a value attribute (e.g., in terms of risk versus reward), and/or another creativity attribute. For instance, classifier 314 can assess whether such generated data samples of generated samples database 310 are novel, surprising, and/or valuable (e.g., in terms of risk versus reward).

In some embodiments, database 316 can comprise one or more novel data samples with desired attributes, which can comprise one or more generated data samples of generated samples database 310 that have been determined to be original data samples (e.g., real data samples) by discriminator 312 and have been determined to be novel, surprising, and/or valuable (e.g., in terms of risk versus reward) by classifier 314. In some embodiments, such novel data samples with desired attributes of database 316 can be assessed (e.g., validated) by an expert entity 318. In some embodiments, expert entity 318 can comprise an expert entity including, but not limited to, a human, a computing device, a software application, an expert agent, an AI model, and/or another expert entity that can assess the novel data samples with desired attributes of database 316 to determine whether such data samples are original data samples (e.g., real data samples) from sample database 302 or synthetic data samples (e.g., fake data samples). In some embodiments, expert entity 318 can assess the value of the novel data samples with desired attributes of database 316 based on one or more creativity attributes corresponding to such novel data samples with desired attributes of database 316. For example, expert entity 318 can assess the value of the novel data samples with desired attributes of database 316 based on a novelty attribute, a surprise attribute, a value attribute (e.g., in terms of risk versus reward), and/or another creativity attribute. For instance, expert entity 318 can assess whether the novel data samples with desired attributes of database 316 are novel, surprising, and/or valuable (e.g., in terms of risk versus reward). In some embodiments, expert entity 318 can perform multi-resolution expert validation. For example, expert entity 318 can assess the novel data samples with desired attributes of database 316 as described above, where such novel data samples with desired attributes can comprise data samples including, but not limited to, single dimension data, multiple dimension data, single resolution data, multiple resolution data, and/or another data sample.

In some embodiments, output determinations by expert entity 318 can be provided to sample database 302 and/or classifier 314 to enable further learning by system 300. For example, output determinations by expert entity 318 comprising validations of novel data samples with desired attributes of database 316 can be stored (e.g., by expert entity 318) in sample database 302 and retrieved by generator 308 to enable further learning by generator 308. In another example, output determinations by expert entity 318 comprising validations of novel data samples with desired attributes of database 316 can be provided (e.g., by expert entity 318) to classifier 314 to enable further learning by classifier 314. In some embodiments, such output determinations by expert entity 318 can enable system 300 (e.g., via generator 308, discriminator 312, classifier 314, etc.) to assess data samples generated by system 300 (e.g., via generator 308) and to learn to generate data samples that become more accurate and/or creative (e.g., novel, surprising, valuable, etc.) over time.

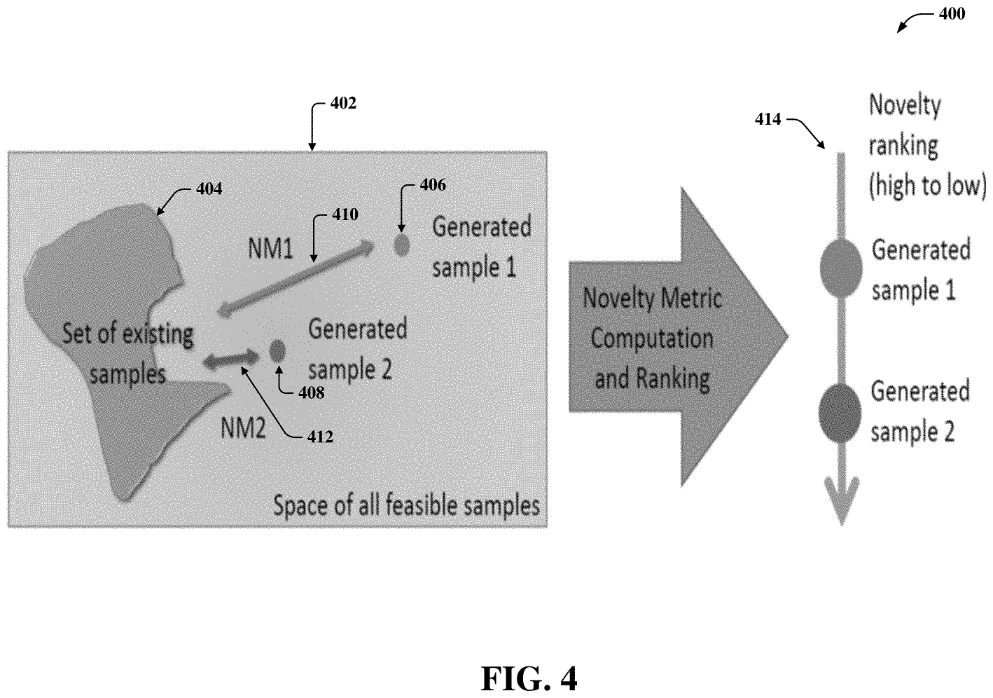

FIG. 4 illustrates a diagram of an example, non-limiting system 400 that can facilitate computational creativity in accordance with one or more embodiments described herein. Repetitive description of like elements and/or processes employed in respective embodiments is omitted for sake of brevity.

According to multiple embodiments, system 400 can comprise a metric computation and ranking system that can be implemented to rank a creative data sample based on a creativity metric. In some embodiments, system 400 can comprise a space 402 and/or a novelty ranking scale 414. In some embodiments, space 402 can comprise a feature space (e.g., an original feature space, a learned feature space, a latent feature space, a learned latent feature space, a vector space, a one-dimensional space, a multi-dimensional space, etc.) corresponding to a creativity attribute (e.g., a novelty attribute, a surprise attribute, a value attribute, a risk attribute, a reward attribute, etc.) of generated data samples and/or an AI model. Although system 400 illustrated in FIG. 4 only references a novelty metric corresponding to a novelty attribute, it should be appreciated that the subject disclosure is not so limited, as system 400 can be utilized with respect to one or more other creativity metrics (e.g., a surprise metric, a value metric, a risk metric, a reward metric, etc.) corresponding to one or more other creativity attributes (e.g., a surprise attribute, a value attribute, a risk attribute, a reward attribute, etc.).

In some embodiments, space 402 can comprise a set of existing data samples 404, one or more generated data samples 406, 408 (e.g., denoted as Generated sample 1 and Generated sample 2, respectively in FIG. 4), and/or one or more distances 410, 412 (e.g., denoted as NM1 and NM2, respectively in FIG. 4 to denote novelty metric 1 and novelty metric 2, respectively). In some embodiments, existing data samples 404 can comprise, for instance, the known, true data samples (e.g., ground truth data, training data, etc.) of sample database 302 described above with reference to FIG. 3. In some embodiments, generated data samples 406, 408 can be generated by, for instance, generator component 110 and/or generator 308 as described above with reference to FIGS. 1 and 3, where such generated data samples 406, 408 can comprise, for instance, the generated data samples of generated samples database 310 and/or the novel data samples with desired attributes of database 316. In some embodiments, distances 410, 412 can comprise, for instance, an edit distance and/or a Euclidian distance between the respective generated data samples 406, 408 and the set of existing data samples 404.

In some embodiments, rank component 206 can employ system 400 to compute a creativity metric and/or rank a creative data sample based on such a creativity metric as described above with reference to FIG. 2. For example, rank component 206 can employ system 400 to compute (e.g., as described above with reference to FIG. 2) novelty metrics corresponding to generated data samples 406, 408 (e.g., distances 410, 412 illustrated in FIG. 4) and/or to rank (e.g., as described above with reference to FIG. 2) generated data samples 406, 408 relative to one another and/or relative to other generated data samples of space 402 based on such novelty metrics. In some embodiments, based on such novelty metrics computation described above (e.g., computation of distances 410, 412 by rank component 206), rank component 206 can generate novelty ranking scale 414 to visually display the rankings of generated data samples 406, 408 relative to one another and/or relative to other generated data samples of space 402 based on such novelty metrics corresponding respectively to generated data samples 406, 408.

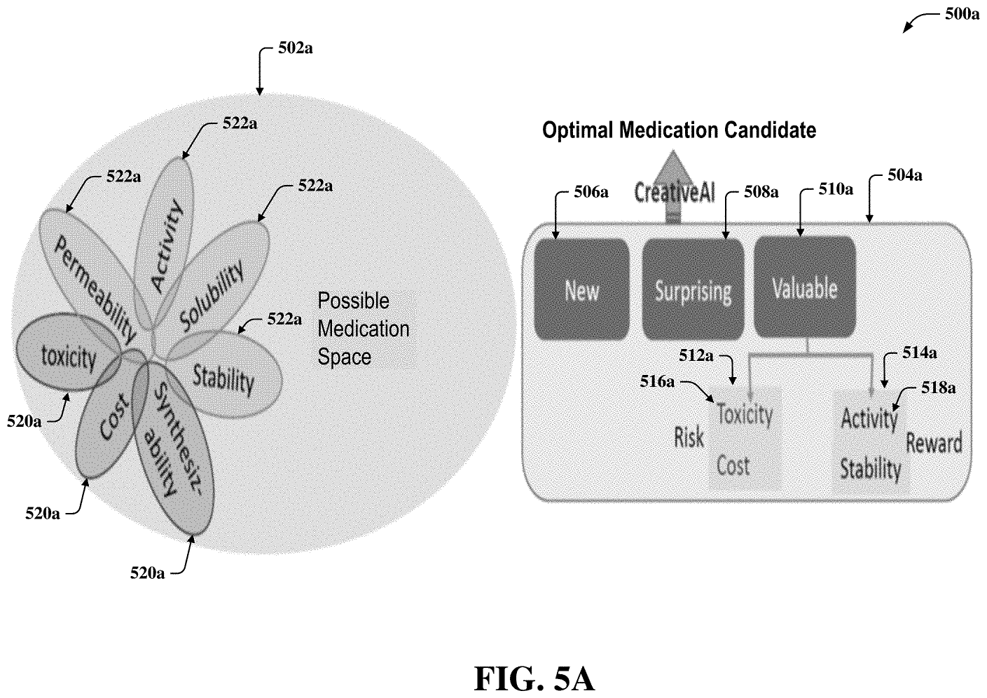

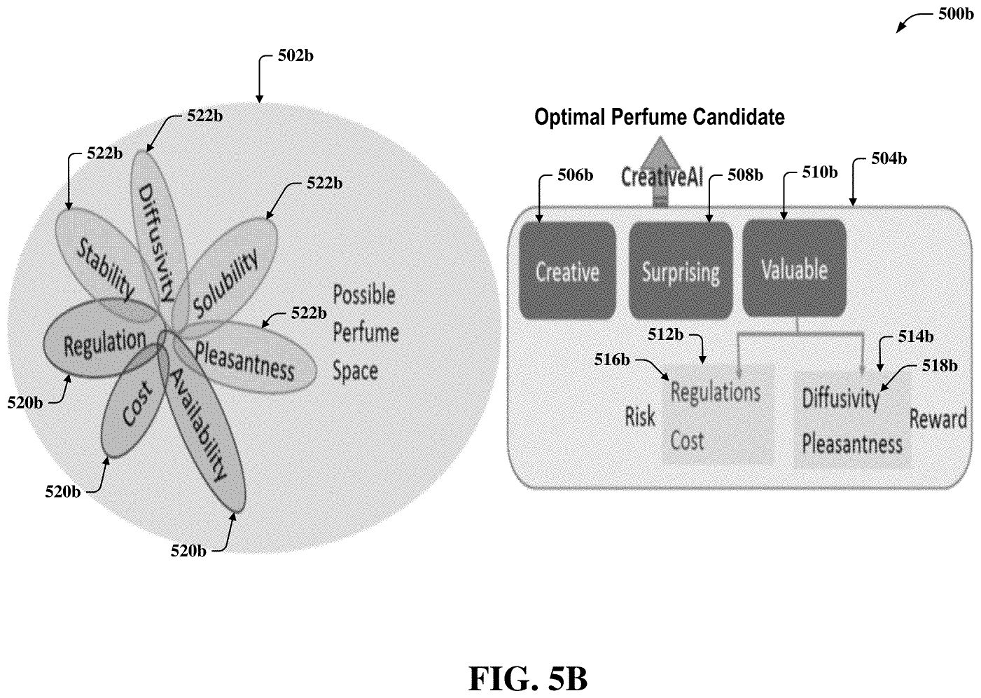

FIGS. 5A and 5B illustrate diagrams of example, non-limiting systems 500a, 500b that can facilitate computational creativity in accordance with one or more embodiments described herein. Repetitive description of like elements and/or processes employed in respective embodiments is omitted for sake of brevity.

According to multiple embodiments, system 500a (FIG. 5A) can comprise a possible medication space 502a and/or a creative AI model 504a that can recommend a medication candidate (e.g., an optimal medication candidate as denoted in FIG. 5A). In some embodiments, creative AI model 504a can comprise one or more tunable creativity control functions 506a, 508a, 510a (e.g., denoted as new, surprising, and valuable, respectively in FIG. 5A). In some embodiments, tunable creativity control function 510a (e.g., denoted as valuable in FIG. 5A) can comprise one or more sub-tunable creativity control functions 512a, 514a (e.g., denoted as risk and reward, respectively in FIG. 5A). In some embodiments, sub-tunable creativity control function 512a (e.g., denoted as risk in FIG. 5A) can comprise one or more second sub-tunable creativity control functions 516a (e.g., denoted as toxicity and cost in FIG. 5A). In some embodiments, sub-tunable creativity control function 514a (e.g., denoted as reward in FIG. 5A) can comprise one or more second sub-tunable creativity control functions 518a (e.g., denoted as activity and stability in FIG. 5A).

In some embodiments, possible medication space 502a can comprise a feature space (e.g., an original feature space, a learned feature space, a latent feature space, a learned latent feature space, a vector space, a one-dimensional space, a multi-dimensional space, etc.) corresponding to a creativity attribute such as, for instance, a valuable attribute of a generated data sample (e.g., the optimal medication candidate denoted in FIG. 5A) and/or an AI model (e.g., creative AI model 504a). In some embodiments, possible medication space 502a can comprise one or more sub-attributes 520a (e.g., denoted as toxicity, cost, and synthesizability in FIG. 5A) that can correspond to, and/or be controlled by adjusting, sub-tunable creativity control function 512a and/or second sub-tunable creativity control functions 516a. In some embodiments, possible medication space 502a can comprise one or more sub-attributes 522a (e.g., denoted as permeability, activity, solubility, and stability in FIG. 5A) that can correspond to, and/or be controlled by adjusting, sub-tunable creativity control function 514a and/or second sub-tunable creativity control functions 518a.

In some embodiments (e.g., as described above with reference to FIG. 1), learner component 108 can learn mappings of data features from a feature space to one or more creativity attributes of an artificial intelligence (AI) model to define one or more creativity control functions of the AI model. For example, learner component 108 can learn mappings of sub-attributes 520a, 522a from possible medication space 502a to sub-tunable creativity control functions 512a, 514a and/or second sub-tunable creativity control functions 516a, 518a.

In some embodiments (e.g., as described above with reference to FIG. 1), generator component 110 can employ an AI model to generate a creative data sample based on one or more creativity control functions of the AI model. For example, generator component 110 can employ creative AI model 504a to generate a creative data sample comprising a recommended medication candidate (e.g., an optimal medication candidate as denoted in FIG. 5A) based on sub-tunable creativity control functions 512a, 514a and/or second sub-tunable creativity control functions 516a, 518a. For instance, generator component 110 can employ creative AI model 504a to generate such a creative data sample (e.g., a recommended medication candidate) by defining and/or adjusting (e.g., as described above with reference to FIG. 1) weight values corresponding to sub-tunable creativity control functions 512a, 514a and/or second sub-tunable creativity control functions 516a, 518a.

According to multiple embodiments, system 500b (FIG. 5B) can comprise a possible perfume space 502b and/or a creative AI model 504b that can recommend a perfume candidate (e.g., an optimal perfume candidate as denoted in FIG. 5B). In some embodiments, creative AI model 504b can comprise one or more tunable creativity control functions 506b, 508b, 510b (e.g., denoted as creative, surprising, and valuable, respectively in FIG. 5B). In some embodiments, tunable creativity control function 510b (e.g., denoted as valuable in FIG. 5B) can comprise one or more sub-tunable creativity control functions 512b, 514b (e.g., denoted as risk and reward, respectively in FIG. 5B). In some embodiments, sub-tunable creativity control function 512b (e.g., denoted as risk in FIG. 5B) can comprise one or more second sub-tunable creativity control functions 516b (e.g., denoted as regulations and cost in FIG. 5B). In some embodiments, sub-tunable creativity control function 514b (e.g., denoted as reward in FIG. 5B) can comprise one or more second sub-tunable creativity control functions 518b (e.g., denoted as diffusivity and pleasantness in FIG. 5B).

In some embodiments, possible perfume space 502b can comprise a feature space (e.g., an original feature space, a learned feature space, a latent feature space, a learned latent feature space, a vector space, a one-dimensional space, a multi-dimensional space, etc.) corresponding to a creativity attribute such as, for instance, a valuable attribute of a generated data sample (e.g., the optimal perfume candidate denoted in FIG. 5B) and/or an AI model (e.g., creative AI model 504b). In some embodiments, possible perfume space 502b can comprise one or more sub-attributes 520b (e.g., denoted as regulation, cost, and availability in FIG. 5B) that can correspond to, and/or be controlled by adjusting, sub-tunable creativity control function 512b and/or second sub-tunable creativity control functions 516b. In some embodiments, possible perfume space 502b can comprise one or more sub-attributes 522b (e.g., denoted as stability, diffusivity, solubility, and pleasantness in FIG. 5B) that can correspond to, and/or be controlled by adjusting, sub-tunable creativity control function 514b and/or second sub-tunable creativity control functions 518b.

In some embodiments (e.g., as described above with reference to FIG. 1), learner component 108 can learn mappings of data features from a feature space to one or more creativity attributes of an artificial intelligence (AI) model to define one or more creativity control functions of the AI model. For example, learner component 108 can learn mappings of sub-attributes 520b, 522b from possible perfume space 502b to sub-tunable creativity control functions 512b, 514b and/or second sub-tunable creativity control functions 516b, 518b.

In some embodiments (e.g., as described above with reference to FIG. 1), generator component 110 can employ an AI model to generate a creative data sample based on one or more creativity control functions of the AI model. For example, generator component 110 can employ creative AI model 504b to generate a creative data sample comprising a recommended perfume candidate (e.g., an optimal perfume candidate as denoted in FIG. 5B) based on sub-tunable creativity control functions 512b, 514b and/or second sub-tunable creativity control functions 516b, 518b. For instance, generator component 110 can employ creative AI model 504b to generate such a creative data sample (e.g., a recommended perfume candidate) by defining and/or adjusting (e.g., as described above with reference to FIG. 1) weight values corresponding to sub-tunable creativity control functions 512b, 514b and/or second sub-tunable creativity control functions 516b, 518b.

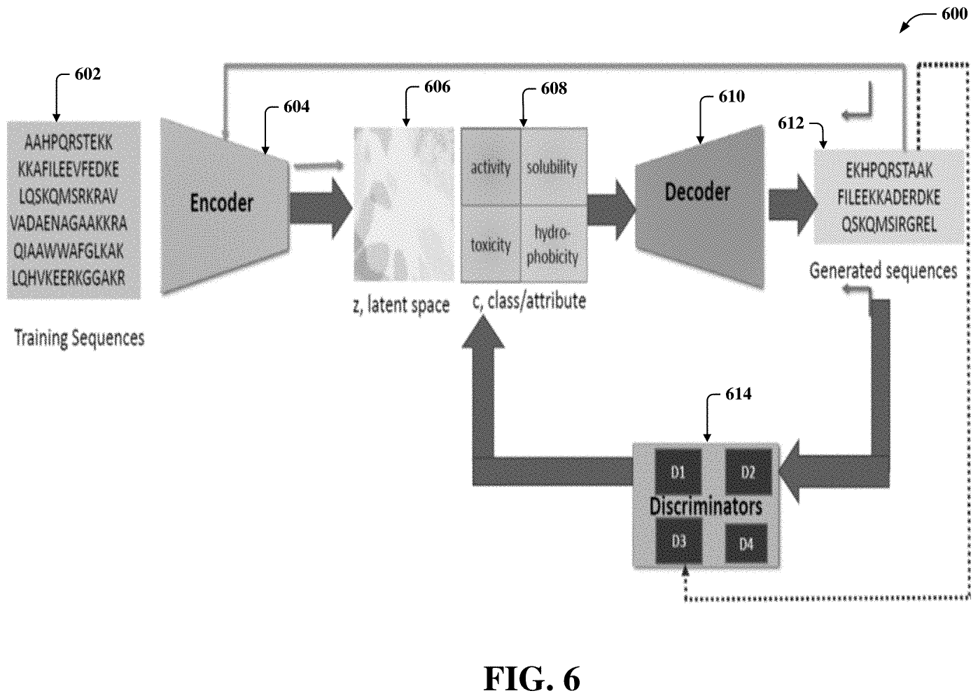

FIG. 6 illustrates a diagram of an example, non-limiting system 600 that can facilitate computational creativity in accordance with one or more embodiments described herein. In some embodiments, system 600 can comprise computational creativity system 102. Repetitive description of like elements and/or processes employed in respective embodiments is omitted for sake of brevity.

According to multiple embodiments, system 600 can comprise an autoencoder model, a variational autoencoder model, and/or a deep generative architecture. In some embodiments, system 600 can comprise one or more training sequences 602, an encoder 604, a latent space 606 (e.g., denoted as z, latent space in FIG. 6), one or more attributes 608 (e.g., denoted as c, class/attribute, activity, solubility, toxicity, and hydrophobicity in FIG. 6), a decoder 610, one or more generated sequences 612, and/or one or more discriminators 614 (e.g., denoted as D1, D2, D3, and D4 in FIG. 6). In some embodiments, encoder 604 and/or decoder 610 can comprise a neural network AI model(s). In some embodiments, one or more of discriminators 614 can comprise discriminator 312 described above with reference to FIG. 3.

In some embodiments, encoder 604 can learn (e.g., as described above with reference to FIG. 1) training sequences 602 and/or can learn to project training sequences 602 into latent space 606, which can comprise a low-dimensional feature space. In some embodiments, latent space 606 can comprise one or more attributes 608 corresponding respectively to one or more data features of latent space 606. In some embodiments, based on learning latent space 606 (e.g., by encoder 604), system 600 (e.g., via encoder 604, decoder 610, and/or discriminators 614) can add (e.g., assign, designate, etc.) one or more attributes 608 to latent space 606 and/or to one or more data features of latent space 606 using a conditional learning technique based on feedback from one or more discriminators 614 (e.g., as illustrated in FIG. 6).

In some embodiments, encoder 604 can learn (e.g., as described above with reference to FIG. 1) training sequences 602, latent space 606, and/or attributes 608 such that encoder 604 can create hidden (e.g., compressed) representations (e.g., vector representations) of training sequences 602, where latent space 606 can comprise such hidden representations of training sequences 602. In some embodiments, using such hidden representations of training sequences 602 in latent space 606, decoder 610 can generate new, synthetic data samples that can comprise generated sequences 612.

In some embodiments, decoder 610 can send such new, synthetic data samples that can comprise generated sequences 612 to encoder 604 to facilitate further leaning by encoder 604 based on such generated sequences 612. In some embodiments, decoder 610 can send such new, synthetic data samples that can comprise generated sequences 612 to one or more discriminators 614 to determine whether such generated sequences 612 are real or fake (e.g., whether such generated sequences 612 are from training sequences 602 or are synthetically generated by decoder 610). In some embodiments, such one or more discriminators 614 can further determine whether such generated sequences 612 can be classified (e.g., labeled) into one or more attributes 608. In some embodiments, each of such one or more discriminators 614 can determine whether generated sequences 612 can be classified (e.g., labeled) into a certain attribute of attributes 608. For example, discriminator D1 illustrated in FIG. 6 can determine whether generated sequences 612 can be classified (e.g., labeled) into a novelty attribute of attributes 608. In another example, discriminator D2 illustrated in FIG. 6 can determine whether generated sequences 612 can be classified (e.g., labeled) into a surprise attribute of attributes 608. In another example, discriminator D3 illustrated in FIG. 6 can determine whether generated sequences 612 can be classified (e.g., labeled) into a value attribute and/or a risk attribute of attributes 608. In another example, discriminator D4 illustrated in FIG. 6 can determine whether generated sequences 612 can be classified (e.g., labeled) into a value attribute and/or a reward attribute of attributes 608.

In some embodiments, based on such determinations performed by one or more discriminators 614 as described above, decoder 610 can learn to generate new, synthetic data samples comprising generated sequences 612 that can resemble training sequences 602 so closely that discriminators 614 cannot distinguish between fake and real data samples in generated sequences 612 and/or cannot distinguish between accurately labeled and inaccurately labeled attributes of such data samples in generated sequences 612.

FIGS. 7A, 7B, 7C, 7D, and 7E illustrate diagrams of example, non-limiting systems 700a, 700b, 700c, 700d, 700e that can facilitate computational creativity in accordance with one or more embodiments described herein. In some embodiments, one or more of systems 700a, 700b, 700c, 700d, 700e can comprise computational creativity system 102. In some embodiments, one or more of systems 700a, 700b, 700c, 700d, 700e can comprise a generative adversarial network (GAN) and/or a derivative system. Repetitive description of like elements and/or processes employed in respective embodiments is omitted for sake of brevity.

According to multiple embodiments, system 700a (FIG. 7A) can comprise a generator 704a (e.g., denoted as Generator G in FIG. 7A) that can receive as input noise 702a and generate as output synthetic data 706a (e.g., denoted as Synthetic Data (X′) in FIG. 7A, where X′ denotes a data feature). In some embodiments, noise 702a can comprise a noise distribution, a Gaussian distribution, and/or one or more D-dimensional noise vectors (where D can denote a total quantity of dimensions). In some embodiments, generator 704a can comprise a neural network AI model such as, for instance, a generative neural network.

In some embodiments, generator 704a can learn a distribution of data features in a feature space (e.g., an original feature space, a learned feature space, a latent feature space, a learned latent feature space, a vector space, a one-dimensional space, a multi-dimensional space, etc.). For example, generator 704a can learn such a distribution of data features in such a feature space based on noise 702a (e.g., as opposed to learning such a distribution of data features from real data such as, for instance, real data 716a, 718a, 720a, 722a). For instance, generator 704a can learn a distribution of data features from noise 702a such that generator 704a can learn to generate synthetic data 706a that mimics real data 716a, 718a, 720a, 722a. In some embodiments, generator 704a can send synthetic data 706a to one or more discriminators 708a, 710a, 712a, 714a (e.g., denoted as Discriminator D1, Discriminator D2, Discriminator D3, and Discriminator D4 in FIG. 7A).

In some embodiments, one or more of discriminators 708a, 710a, 712a, 714a can comprise a neural network AI model such as, for instance, a discriminative neural network. In some embodiments, discriminators 708a, 710a, 712a, 714a can respectively receive real data 716a, 718a, 720a, 722a (e.g., denoted as Real Data (X¹, y¹), Real Data (X², y²), Real Data (X³, y³), and Real Data (X⁴, y⁴), respectively in FIG. 7A, where X¹, X², X³, and X⁴ denote data features and y¹, y², y³, and y⁴ denote an attribute). In some embodiments, real data 716a, 718a, 720a, 722a can comprise known, original, and/or true data samples (e.g., ground truth data, training data, etc.).

In some embodiments, discriminators 708a, 710a, 712a, 714a can comprise tunable creativity control functions of system 700a that can respectively correspond to a certain creativity attribute (e.g., novelty, surprise, value in terms of risk versus reward, etc.). In some embodiments, discriminators 708a, 710a, 712a, 714a can respectively determine whether synthetic data 706a comprises real or fake data samples (e.g., by comparing synthetic data 706a to real data 716a, 718a, 720a, 722a, respectively). In some embodiments, discriminators 708a, 710a, 712a, 714a can respectively predict whether synthetic data 706a comprises a certain creativity attribute (e.g., by comparing synthetic data 706a to real data 716a, 718a, 720a, 722a, respectively). For example, discriminator 708a (e.g., denoted as Discriminator D1 in FIG. 7A) can predict whether synthetic data 706a comprises a novelty attribute. In another example, discriminator 710a (e.g., denoted as Discriminator D2 in FIG. 7A) can predict whether synthetic data 706a comprises a surprise attribute. In another example, discriminator 712a (e.g., denoted as Discriminator D3 in FIG. 7A) can predict whether synthetic data 706a comprises a value attribute and/or a risk attribute. In another example, discriminator 714a (e.g., denoted as Discriminator D4 in FIG. 7A) can predict whether synthetic data 706a comprises a value attribute and/or a reward attribute.

In some embodiments, generator 704a can learn to generate synthetic data 706a that mimics real data 716a, 718a, 720a, 722a based on feedback data from one or more of discriminators 708a, 710a, 712a, 714a. In some embodiments, a weight value corresponding to one or more discriminators 708a, 710a, 712a, 714a can be adjusted (e.g., based on feedback data from such one or more discriminators 708a, 710a, 712a, 714a) to regulate the ability of such one or more discriminators 708a, 710a, 712a, 714a to determine sample generation (e.g., to determine whether synthetic data 706a is real or fake, etc.). In some embodiments, such adjustment can be facilitated by training discriminators 708a, 710a, 712a, 714a with different frequency (e.g., more or less frequent) and/or by changing a weight value of a particular discriminator's feedback data.

According to multiple embodiments, system 700b (FIG. 7B) can comprise a non-limiting alternative example embodiment of system 700a, where system 700b can comprise generator 702b (e.g., denoted as Generator in FIG. 7B) that can receive as input noise 702a and generate as output synthetic data 704b (e.g., denoted as Synthetic Data (X′, y′) in FIG. 7B, where X′ denotes a data feature and y′ denotes an attribute) that can be assessed by discriminator 706b (e.g., denoted as Discriminator D in FIG. 7B). In some embodiments, generator 702b can comprise a neural network

AI model such as, for instance, a generative neural network. In some embodiments, generator 702b can comprise a multi-class classifier AI model.

In some embodiments, generator 702b can learn a distribution of data features in a feature space (e.g., an original feature space, a learned feature space, a latent feature space, a learned latent feature space, a vector space, a one-dimensional space, a multi-dimensional space, etc.). For example, generator 702b can learn such a distribution of data features in such a feature space based on noise 702a (e.g., as opposed to learning such a distribution of data features from real data such as, for instance, real data 716a, 718a, 720a, 722a). In some embodiments, generator 702b can learn a distribution of data features from noise 702a such that generator 702b can learn all mappings across all attributes of such a distribution. For example, generator 702b can learn mappings of such data features from noise 702a to one or more creativity attributes of discriminator 706b. For instance, generator 702b can learn mappings of such data features from noise 702a to one or more tunable creativity control functions of discriminator 706b that can respectively correspond to a certain creativity attribute (e.g., novelty, surprise, value in terms of risk versus reward, etc.). In some embodiments, generator 702b can learn a distribution of data features from noise 702a such that generator 702b can learn to generate synthetic data 704b that mimics real data 716a, 718a, 720a, 722a. In some embodiments, generator 702b can send synthetic data 704b to discriminator 706b.

In some embodiments, discriminator 706b can comprise a neural network AI model such as, for instance, a discriminative neural network. In some embodiments, discriminator 706b can receive real data 716a, 718a, 720a, 722a that can comprise known, original, and/or true data samples (e.g., ground truth data, training data, etc.). In some embodiments, discriminator 706b can comprise one or more tunable creativity control functions that can respectively correspond to a certain creativity attribute (e.g., novelty, surprise, value in terms of risk versus reward, etc.). In some embodiments, discriminator 706b can determine whether synthetic data 704b comprises real or fake data samples (e.g., by comparing synthetic data 704b to real data 716a, 718a, 720a, 722a, respectively). In some embodiments, discriminator 706b can predict whether synthetic data 704b comprises a certain creativity attribute (e.g., by comparing synthetic data 704b to real data 716a, 718a, 720a, 722a, respectively). For example, discriminator 706b can predict whether synthetic data 704b comprises a certain creativity attribute including, but not limited to, a novelty attribute, a surprise attribute, a value attribute (e.g., in terms of risk versus reward), a risk attribute, a reward attribute, and/or another creativity attribute.

According to multiple embodiments, system 700c (FIG. 7C) can comprise a non-limiting alternative example embodiment of system 700a and/or system 700b, where system 700c can comprise an encoder 702c that can learn a distribution of data features in a feature space (e.g., an original feature space, a learned feature space, a latent feature space, a learned latent feature space, a vector space, a one-dimensional space, a multi-dimensional space, etc.) based on real data 716a, 718a, 720a, 722a (e.g., as opposed to learning such a distribution of data features from a noise distribution as described above with reference to FIGS. 7A and 7B). In some embodiments, encoder 702c can generate noise 702a, which can be used by generator 702b to generate synthetic data 706a. For example, encoder 702c can comprise a neural network AI model that can map real data 716a, 718a, 720a, 722a into a feature space described above and generator 702b can generate synthetic data 706a from such a feature space. In some embodiments, encoder 702c can comprise encoder 604 described above with reference to FIG. 6. In some embodiments, system 700c (e.g., generator 702b, discriminator 706b, and/or encoder 702c) can learn a distribution of data features in such a feature space described above based on real data 716a, 718a, 720a, 722a. For example, encoder 702c can learn such a distribution based on real data 716a, 718a, 720a, 722a and generator 702b can learn such a distribution based on feedback data from encoder 702c and/or discriminator 706b.

According to multiple embodiments, system 700d (FIG. 7D) can comprise a non-limiting alternative example embodiment of system 700a, system 700b, and/or system 700c where system 700d can comprise a model 702d, a predictor 704d, and/or a judge 706d. In some embodiments, model 702d can comprise a non-limiting alternative example embodiment of system 700b, where model 702d can learn an original distribution of data features in a feature space based on noise 702a and/or real data 708d, 710d, 712d, 714d (e.g., denoted as Real Data (X¹), Real Data (X²), Real Data (X³), and Real Data (X⁴), respectively in FIG. 7D, where X¹, X², X³, and X⁴ denote data features). In some embodiments, based on such a learned distribution of data features, model 702d can generate a data feature Xi that can mimic real data 708d, 710d, 712d, 714d.

In some embodiments, predictor 704d can comprise a neural network AI model (e.g., a classifier AI model) that can predict a label and/or a classification of a data feature Xᵢ that can be generated by model 702d. For example, predictor 704d can predict a label and/or a classification of data feature Xᵢ, where such a label and/or a classification can comprise attribute yᵢ illustrated in FIG. 7D. In this example, data feature Xᵢ can comprise a creative data sample that can be generated by model 702d and attribute yᵢ can comprise a creativity attribute corresponding to such data feature Xᵢ that can be predicted by predictor 704d.

In some embodiments, judge 706d can comprise a neural network AI model (e.g., a discriminative AI model) that can determine whether an attribute yᵢ was actually predicted by a computing entity (e.g., a computing device employing an artificial intelligence model and/or a machine learning model) or a human. In some embodiments, judge 706d can determine whether such an attribute yᵢ was actually predicted by a computing entity or a human based on labeled data denoted as Labeled (X, y) in FIG. 7D. In some embodiments, such labeled data denoted as Labeled (X, y) in FIG. 7D can comprise known, original, and/or true data samples (e.g., ground truth data, training data, etc.).

According to multiple embodiments, system 700e (FIG. 7E) can comprise a non-limiting alternative example embodiment of system 700a, system 700b, system 700c, and/or system 700d where system 700e can comprise a ranking function predictor 702e, a predicted score 704e, and/or expert feedback 706e. In some embodiments, system 700e can comprise system 700b, which can generate predicted score 704e that can comprise a data feature Xᵢ and/or a label and/or a classification of such a data feature Xᵢ that can comprise attribute yᵢ illustrated in FIG. 7E. In this example, data feature Xᵢ and/or attribute yᵢ can be generated and/or predicted by system 700b as illustrated in FIG. 7E. In some embodiments, system 700b can generate and/or predict data feature Xᵢ and/or attribute yᵢ and rank component 206 can compute a creativity metric and/or a ranking designation corresponding to data feature Xᵢ and/or attribute yᵢ as described above with reference to FIG. 2. In some embodiments, such a creativity metric and/or ranking designation can constitute predicted score 704e.

In some embodiments, ranking function predictor 702e can receive as input predicted score 704e and/or expert feedback 706e, which can comprise expert feedback data from an expert entity (e.g., a human expert, a physics simulator, a computing device employing an artificial intelligence model and/or a machine learning model, etc.). In some embodiments, expert feedback 706e can comprise expert feedback data where such an expert entity was provided a data feature Xᵢ that can be generated by system 700b and such an expert entity predicted attribute y*ᵢ based on data feature Xᵢ as illustrated in FIG. 7E.

In some embodiments, ranking function predictor 702e can determine whether a synthesized sample is top ranked. For example, ranking function predictor 702e can determine whether attribute yᵢ is top ranked in terms of a one or more certain creativity attributes (e.g., novelty, surprise, value, risk, reward, etc.). In some embodiments, ranking function predictor 702e can comprise rank component 206 and ranking function predictor 702e can determine whether attribute yᵢ is top ranked in terms of a one or more certain creativity attributes (e.g., novelty, surprise, value, risk, reward, etc.) by employing the creativity metric computation and ranking process described above with reference to rank component 206 and FIG. 2.

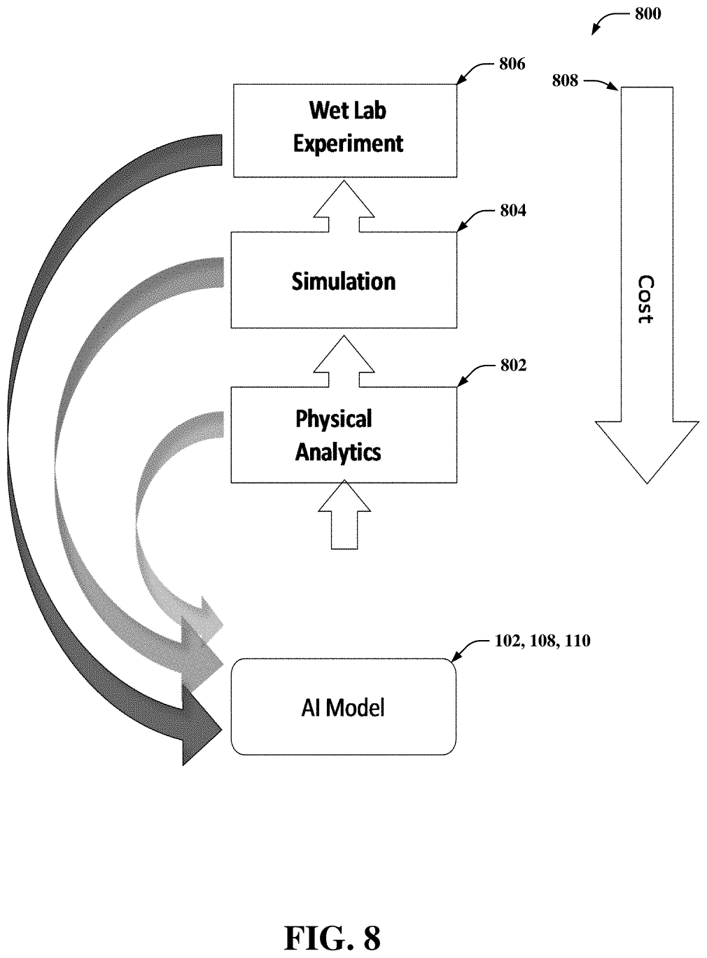

FIG. 8 illustrates a diagram of an example, non-limiting information 800 that can facilitate computational creativity in accordance with one or more embodiments described herein. Repetitive description of like elements and/or processes employed in respective embodiments is omitted for sake of brevity.

According to multiple embodiments, information 800 can comprise a representation of various expert entity feedback data that can be provided to computational creativity system 102 and/or one or more components thereof, where such various expert entity feedback data can be used to train computational creativity system 102 and/or one or more components thereof in accordance with one or more embodiments described herein. In some embodiments, information 800 can comprise a representation of various expert entity feedback data including, but not limited to, physical analytics feedback data 802 (e.g., information and/or data analytics based feedback data, etc.), simulation feedback data 804 (e.g., a physics simulation feedback data, etc.), wet lab experiment feedback data 806 (e.g., human expert feedback data), and/or other expert entity feedback data that can be provided to computational creativity system 102 and/or one or more components thereof (e.g., learner component 108, generator component 110, etc.) to facilitate training such system and/or components in accordance with one or more embodiments described herein. In some embodiments, information 800 can comprise a cost scale 808 that can comprise a representation of cost (e.g., computational cost) associated with such various expert entity feedback data described above (e.g., physical analytics feedback data 802, simulation feedback data 804, wet lab experiment feedback data 806, etc.).

In some embodiments, computational creativity system 102 can be associated with various technologies. For example, computational creativity system 102 can be associated with artificial intelligence technologies, machine learning technologies, creative artificial intelligence technologies, creative machine learning technologies, data analytics technologies, computer technologies, server technologies, information technology (IT) technologies, internet-of-things (IoT) technologies, automation technologies, and/or other technologies.

In some embodiments, computational creativity system 102 can provide technical improvements to systems, devices, components, operational steps, and/or processing steps associated with the various technologies identified above. For example, computational creativity system 102 can automatically (e.g., without assistance from a human): learn mappings of data features from a feature space to a creativity attribute of an artificial intelligence model to define a creativity control function of the artificial intelligence model; and/or employ the AI model to generate a creative data sample based on the creativity control function. In this example, computational creativity system 102 can learn the mappings based on expert feedback data, thereby facilitating an increased value of a creativity metric corresponding to the creative data sample, which can enable computational creativity system 102 to generate creative data samples that become relatively more creative over time in terms of, for instance, novelty, surprise, value, risk, and/or reward.

In some embodiments, computational creativity system 102 can provide technical improvements to a processing unit (e.g., processor 106) associated with a classical computing device and/or a quantum computing device (e.g., a quantum processor, quantum hardware, superconducting circuit, etc.). For example, by generating creative data samples that become relatively more creative over time, computational creativity system 102 can thereby facilitate reduced processing cycles performed by processor 106 to generate accurate and/or desired creative data samples and such reduced processing cycles can reduce computation cost of processor 106.

In some embodiments, computational creativity system 102 can employ hardware or software to solve problems that are highly technical in nature, that are not abstract and that cannot be performed as a set of mental acts by a human. In some embodiments, some of the processes described herein can be performed by one or more specialized computers (e.g., one or more specialized processing units, a specialized quantum computer, etc.) for carrying out defined tasks related to the various technologies identified above. In some embodiments, computational creativity system 102 and/or components thereof, can be employed to solve new problems that arise through advancements in technologies mentioned above, employment of quantum computing systems, cloud computing systems, computer architecture, and/or another technology.

It is to be appreciated that computational creativity system 102 can utilize various combinations of electrical components, mechanical components, and circuitry that cannot be replicated in the mind of a human or performed by a human, as the various operations that can be executed by computational creativity system 102 and/or components thereof as described herein are operations that are greater than the capability of a human mind. For instance, the amount of data processed, the speed of processing such data, or the types of data processed by computational creativity system 102 over a certain period of time can be greater, faster, or different than the amount, speed, or data type that can be processed by a human mind over the same period of time.

According to several embodiments, computational creativity system 102 can also be fully operational towards performing one or more other functions (e.g., fully powered on, fully executed, etc.) while also performing the various operations described herein. It should be appreciated that such simultaneous multi-operational execution is beyond the capability of a human mind. It should also be appreciated that computational creativity system 102 can include information that is impossible to obtain manually by an entity, such as a human user. For example, the type, amount, or variety of information included in computational creativity system 102, learner component 108, generator component 110, expert component 202, tuner component 204, rank component 206, predictor component 208, and/or judge component 210 can be more complex than information obtained manually by a human user.

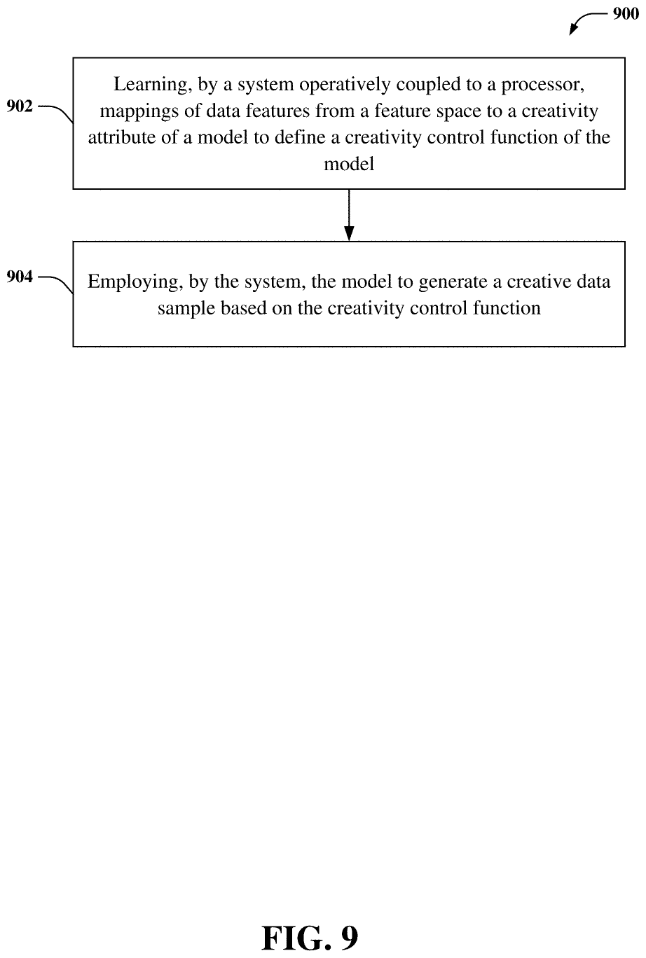

FIG. 9 illustrates a flow diagram of an example, non-limiting computer-implemented method 900 that can facilitate computational creativity in accordance with one or more embodiments described herein. Repetitive description of like elements and/or processes employed in respective embodiments is omitted for sake of brevity.

In some embodiments, at 902, computer-implemented method 900 can comprise learning, by a system (e.g., computational creativity system 102 and/or learner component 108) operatively coupled to a processor (e.g., processor 106), mappings of data features from a feature space to a creativity attribute of a model (e.g., an AI model defined above with reference to FIG. 1) to define a creativity control function of the model. For example, computational creativity system 102 and/or learner component 108 can learn mappings of data features from a feature space (e.g., an original feature space, a learned feature space, a latent feature space, a learned latent feature space, a vector space, a one-dimensional space, a multi-dimensional space, etc.) to a creativity attribute (e.g., a novelty attribute, a surprise attribute, a value attribute, a risk attribute, a reward attribute, etc.) of an AI model (e.g., computational creativity system 102, learner component 108, generator component 110, etc.) to define a creativity control function of the AI model (e.g., a tunable creativity control function indicative of a tunable creativity control knob that can be adjusted to alter a weight value of such a creativity attribute as described herein with reference to FIGS. 1, 2, 3, 4, 5A, 5B, 6, 7A, 7B, 7C, 7D, and/or 7E).

In some embodiments, at 904, computer-implemented method 900 can comprise employing, by the system (e.g., computational creativity system 102 and/or generator component 110), the model to generate a creative data sample based on the creativity control function. For instance, as described above with reference to FIG. 1, generator component 110 can employ an AI model to generate a creative data sample based on a weighted value of a creativity control function comprising a tunable creativity control function that can be adjusted to alter such a weighted value.

For simplicity of explanation, the computer-implemented methodologies are depicted and described as a series of acts. It is to be understood and appreciated that the subject innovation is not limited by the acts illustrated or by the order of acts, for example acts can occur in various orders or concurrently, and with other acts not presented and described herein. Furthermore, not all illustrated acts can be required to implement the computer-implemented methodologies in accordance with the disclosed subject matter. In addition, those skilled in the art will understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from any computer-readable device or storage media.

In order to provide a context for the various aspects of the disclosed subject matter, FIG. 10 as well as the following discussion are intended to provide a general description of a suitable environment in which the various aspects of the disclosed subject matter can be implemented. FIG. 10 illustrates a block diagram of an example, non-limiting operating environment in which one or more embodiments described herein can be facilitated. Repetitive description of like elements and/or processes employed in other embodiments described herein is omitted for sake of brevity.

With reference to FIG. 10, a suitable operating environment 1000 for implementing various aspects of this disclosure can also include a computer 1012. The computer 1012 can also include a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014. The system bus 1018 can be any of several types of bus structure(s) including the memory bus or memory controller, a peripheral bus or external bus, or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI).

The system memory 1016 can also include volatile memory 1020 and nonvolatile memory 1022. The basic input/output system (BIOS), containing the basic routines to transfer information between elements within the computer 1012, such as during start-up, is stored in nonvolatile memory 1022. Computer 1012 can also include removable/non-removable, volatile/non-volatile computer storage media. FIG. 10 illustrates, for example, a disk storage 1024. Disk storage 1024 can also include, but is not limited to, devices like a magnetic disk drive, floppy disk drive, tape drive, Jaz drive, Zip drive, LS-100 drive, flash memory card, or memory stick. The disk storage 1024 also can include storage media separately or in combination with other storage media. To facilitate connection of the disk storage 1024 to the system bus 1018, a removable or non-removable interface is typically used, such as interface 1026. FIG. 10 also depicts software that acts as an intermediary between users and the basic computer resources described in the suitable operating environment 1000. Such software can also include, for example, an operating system 1028. Operating system 1028, which can be stored on disk storage 1024, acts to control and allocate resources of the computer 1012.

System applications 1030 take advantage of the management of resources by operating system 1028 through program modules 1032 and program data 1034, e.g., stored either in system memory 1016 or on disk storage 1024. It is to be appreciated that this disclosure can be implemented with various operating systems or combinations of operating systems. A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port can be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices or systems of devices provide both input and output capabilities such as remote computer(s) 1044.

Computer 1012 can operate in a networked environment using logical connections to one or more remote computers, such as remote computer(s) 1044. The remote computer(s) 1044 can be a computer, a server, a router, a network PC, a workstation, a microprocessor based appliance, a peer device or other common network node and the like, and typically can also include many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 1050 refers to the hardware/software employed to connect the network interface 1048 to the system bus 1018. While communication connection 1050 is shown for illustrative clarity inside computer 1012, it can also be external to computer 1012. The hardware/software for connection to the network interface 1048 can also include, for exemplary purposes only, internal and external technologies such as, modems including regular telephone grade modems, cable modems and DSL modems, ISDN adapters, and Ethernet cards.

Referring now to FIG. 11, an illustrative cloud computing environment 1150 is depicted. As shown, cloud computing environment 1150 includes one or more cloud computing nodes 1110 with which local computing devices used by cloud consumers, such as, for example, personal digital assistant (PDA) or cellular telephone 1154A, desktop computer 1154B, laptop computer 1154C, and/or automobile computer system 1154N may communicate. Nodes 1110 may communicate with one another. They may be grouped (not shown) physically or virtually, in one or more networks, such as Private, Community, Public, or Hybrid clouds as described hereinabove, or a combination thereof. This allows cloud computing environment 1150 to offer infrastructure, platforms and/or software as services for which a cloud consumer does not need to maintain resources on a local computing device. It is understood that the types of computing devices 1154A-N shown in FIG. 11 are intended to be illustrative only and that computing nodes 1110 and cloud computing environment 1150 can communicate with any type of computerized device over any type of network and/or network addressable connection (e.g., using a web browser).

Referring now to FIG. 12, a set of functional abstraction layers provided by cloud computing environment 1150 (FIG. 11) is shown. It should be understood in advance that the components, layers, and functions shown in FIG. 12 are intended to be illustrative only and embodiments of the invention are not limited thereto. As depicted, the following layers and corresponding functions are provided:

Hardware and software layer 1260 includes hardware and software components. Examples of hardware components include: mainframes 1261; RISC (Reduced Instruction Set Computer) architecture based servers 1262; servers 1263; blade servers 1264; storage devices 1265; and networks and networking components 1266. In some embodiments, software components include network application server software 1267 and database software 1268.

Virtualization layer 1270 provides an abstraction layer from which the following examples of virtual entities may be provided: virtual servers 1271; virtual storage 1272; virtual networks 1273, including virtual private networks; virtual applications and operating systems 1274; and virtual clients 1275.

In one example, management layer 1280 may provide the functions described below. Resource provisioning 1281 provides dynamic procurement of computing resources and other resources that are utilized to perform tasks within the cloud computing environment. Metering and Pricing 1282 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1283 provides access to the cloud computing environment for consumers and system administrators. Service level management 1284 provides cloud computing resource allocation and management such that required service levels are met. Service Level Agreement (SLA) planning and fulfillment 1285 provide pre-arrangement for, and procurement of, cloud computing resources for which a future requirement is anticipated in accordance with an SLA.

Workloads layer 1290 provides examples of functionality for which the cloud computing environment may be utilized. Non-limiting examples of workloads and functions which may be provided from this layer include: mapping and navigation 1291; software development and lifecycle management 1292; virtual classroom education delivery 1293; data analytics processing 1294; transaction processing 1295; and computational creativity software 1296.

The present invention may be a system, a method, an apparatus or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations or block diagrams of methods, apparatus (systems), and computer program products according to embodiments of the invention. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus, or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that this disclosure also can or can be implemented in combination with other program modules. Generally, program modules include routines, programs, components, data structures, etc. that perform particular tasks or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system, or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components; and
a processor that executes the computer executable components stored in the memory, wherein the computer executable components comprise:
a learner component that learns mappings of data features from a feature space to a creativity attribute of a model to define a creativity control function of the model; and
a generator component that employs the model to generate a creative data sample based on the creativity control function.

2. The system of claim 1, wherein the learner component learns the mappings of the data features from the feature space to multiple creativity attributes of the model to define multiple creativity control functions of the model, and wherein the multiple creativity control functions comprise one or more weight values.

3. The system of claim 1, wherein the creativity attribute is selected from a group consisting of novelty, surprise, value, risk, and reward.

4. The system of claim 1, wherein the learner component learns the mappings based on at least one of feedback data, single dimension data, multiple dimension data, single resolution data, or multiple resolution data, thereby facilitating at least one of an increased value of a creativity metric corresponding to the creative data sample or reduced computation cost of the processor.

5. The system of claim 1, wherein the computer executable components further comprise:
an expert component that assesses authenticity of the creative data sample based on historical data.

6. The system of claim 1, wherein the computer executable components further comprise:
a tuner component that adjusts a weight value of the creativity control function based on at least one of expert feedback data or a defined weight value of the creativity control function.

7. The system of claim 1, wherein the computer executable components further comprise:
a rank component that ranks the creative data sample based on a creativity metric.

8. The system of claim 1, wherein the computer executable components further comprise:
a predictor component that predicts the creativity attribute based on the creative data sample; and
a judge component that determines whether the creativity attribute was predicted by the predictor component or an entity.

9. A computer-implemented method, comprising:
learning, by a system operatively coupled to a processor, mappings of data features from a feature space to a creativity attribute of a model to define a creativity control function of the model; and
employing, by the system, the model to generate a creative data sample based on the creativity control function.

10. The computer-implemented method of claim 9, wherein the learning comprises:
learning, by the system, the mappings of the data features from the feature space to multiple creativity attributes of the model to define multiple creativity control functions of the model, and wherein the multiple creativity control functions comprise one or more weight values.

11. The computer-implemented method of claim 9, wherein the creativity attribute is selected from a group consisting of novelty, surprise, value, risk, and reward.

12. The computer-implemented method of claim 9, wherein the learning comprises:
learning, by the system, the mappings based on at least one of feedback data, single dimension data, multiple dimension data, single resolution data, or multiple resolution data, thereby facilitating at least one of an increased value of a creativity metric corresponding to the creative data sample or reduced computation cost of the processor.

13. The computer-implemented method of claim 9, wherein the learning comprises:
assessing, by the system, authenticity of the creative data sample based on historical data.

14. The computer-implemented method of claim 9, wherein the learning comprises:
adjusting, by the system, a weight value of the creativity control function based on at least one of expert feedback data or a defined weight value of the creativity control function.

15. The computer-implemented method of claim 9, wherein the learning comprises:
ranking, by the system, the creative data sample based on a creativity metric.

16. The computer-implemented method of claim 9, wherein the learning comprises:
predicting, by the system, the creativity attribute based on the creative data sample; and
determining, by the system, whether the creativity attribute was predicted by a computing entity or a human entity.

17. A computer program product facilitating computational creativity, the computer program product comprising a computer readable storage medium having program instructions embodied therewith, the program instructions executable by a processor to cause the processor to:
learn, by the processor, mappings of data features from a feature space to a creativity attribute of a model to define a creativity control function of the model; and
employ, by the processor, the model to generate a creative data sample based on the creativity control function.

18. The computer program product of claim 17, wherein the program instructions are further executable by the processor to cause the processor to:
assess, by the processor, authenticity of the creative data sample based on historical data; and
adjust, by the processor, a weight value of the creativity control function based on at least one of expert feedback data or a defined weight value of the creativity control function.

19. The computer program product of claim 17, wherein the program instructions are further executable by the processor to cause the processor to:
rank, by the processor, the creative data sample based on a creativity metric.

20. The computer program product of claim 17, wherein the program instructions are further executable by the processor to cause the processor to:
predict, by the processor, the creativity attribute based on the creative data sample; and
determine, by the processor, whether the creativity attribute was predicted by a computing entity or a human entity.
